(19) United States
(12) Patent Application Publication
(10) Pub. No.: US 2023/0049400 A1
(43) Pub. Date: Feb. 16, 2023

(54) METHODS FOR PREPARING HARD CARBON BY ACID OXIDATION

(71) Applicant: PHILLIPS 66 COMPANY, HOUSTON, TX (US)

(72) Inventors: Kan Huang, Sterling Heights, MI (US); Liang Zhang, Owasso, OK (US); Christopher J. LaFrancois, Bartlesville, OK (US); Brian J. Worfolk, Raleigh, NC (US)

(73) Assignee: PHILLIPS 66 COMPANY, HOUSTON, TX (US)

(21) Appl. No.: 17/873,493

(22) Filed: Jul. 26, 2022

Related U.S. Application Data
(60) Provisional application No. 63/230,868, filed on Aug. 9, 2021.
(60) Provisional application No. 63/304,811, filed on Jan. 31, 2022.
(60) Provisional application No. 63/304,931, filed on Jan. 31, 2022.

(51) Int. Cl. H01M 4/587; C01B 32/05; C10G 27/04

(52) U.S. Cl. CPC H01M 4/587; C01B 32/05; C10G 27/04; C01P 2006/40; C01P 2002/72; H01M 2004/027

(57) ABSTRACT

Embodiments of the present disclosure generally relate to methods for preparing carbon materials which can be used in battery electrodes. In one or more embodiments, a method for preparing an anode carbon material is provided and includes combining a liquid refinery hydrocarbon product and a solvent to produce a first mixture, combining the first mixture and a first oxidizing agent containing an acid to produce a second mixture containing the liquid refinery hydrocarbon product, the solvent, and the first oxidizing agent, and heating the second mixture to produce a reaction mixture containing an oxidized solid product during an oxidation process. The method also includes separating the oxidized solid product from the reaction mixture during a separation process and carbonizing the oxidized solid product to produce a hard carbon product during a carbonization process.

### CROSS-REFERENCE TO RELATED APPLICATIONS

This application is a Non-Provisional patent application which claims the benefit of and priority to U.S. Provisional Patent Application Ser. No. 63/230,868 filed Aug. 9, 2021, entitled “Multi Functionalization of Petroleum Products”, U.S. Provisional Application Ser. No. 63/304,811 filed Jan. 31, 2022, entitled “Methods for Preparing Nano-Ordered Carbon Products from Petroleum Streams” and U.S. Provisional Application Ser. No. 63/304,931 filed Jan. 31, 2022, entitled “Methods for Preparing Hard Carbon by Acid Oxidation” all of which are hereby incorporated by reference in their entirety.

### BACKGROUND

### Field

Embodiments of the present disclosure generally relate to battery technology, and more specifically, methods for preparing carbon-based materials used in battery technology.

### Description of the Related Art

Metal ion rechargeable batteries, especially lithium-ion batteries, are widely used secondary battery systems for portable electronic devices, electric vehicles, and other electrically powered devices. Lithium-ion battery technology has enjoyed a lot of attention in recent years and provides the preferred portable battery for most electronic devices in use today. However, lithium is not a cheap metal to source and is considered too expensive for use in large scale battery applications. By contrast sodium-ion battery technology is still in a relative infancy stage but is seen as having many advantages over lithium. Sodium is a more abundant element than lithium. As such, some researchers predict sodium-ion batteries will provide a cheaper and more durable way to store energy into the future, particularly for large scale applications such as storing energy on the electrical grid. Nevertheless, a lot of work has to be done before sodium-ion batteries are a commercial reality.

Sodium-ion batteries are analogous in many ways to the lithium-ion batteries that are in common use today. Both types of batteries are reusable secondary batteries that include an anode (negative electrode), a cathode (positive electrode), and an electrolyte material. Also, both types of batteries are capable of charging and discharging via a similar reaction mechanism. When a sodium-ion (or lithium-ion) battery is charging, the metal ions (Na+ or Li+) de-intercalate from the cathode and insert into the anode. Meanwhile charge balancing electrons pass from the cathode through the external circuit containing the charger and into the anode of the battery. During discharge the same process occurs but in the opposite direction.

For example, in the use of sodium based batteries, hard carbon or soft carbon, has been conventionally derived from biomass feedstocks that contain significant amounts of oxygen. These feedstocks are difficult to collect due to localized nature, difficult to process due to large amount of impurities, and challenging to control quality which leads to inconsistent product. In addition, the yield from these feedstocks are known to be low, such as about 10%-20%.

The use of using heavy refinery hydrocarbon streams are ideal as natural building blocks for value-added carbonaceous materials in batteries. Conventional approaches to making hard carbon products from petroleum-based feedstock usually are carried out via a lengthy process. For example, a hard carbon material can be made from a petroleum pitch by mixing the pitch with an additive in a heated molten state followed by extruding into pellets, emulsification into micro-sized particles, removing additives by solvent washing, air oxidation in fluidized bed reactor, and calcining in high temperature furnace.

Therefore, there is a need for improved methods to prepare carbon materials capable of having high specific capacity and desired structural parameters, and where the methods are faster, more efficient, and produce greater yields than traditional methods for preparing similar carbon materials.

### SUMMARY

Embodiments of the present disclosure generally relate to methods for preparing carbon materials which can be used in battery electrodes. More specifically, embodiments relate to methods for preparing anodic materials from heavy hydrocarbon streams and an oxidizing agent containing an acid. The heavy hydrocarbon streams can include polyaromatic hydrocarbons, such as a fluid catalytic cracking (FCC) slurry oil, and the oxidizing agent can contain nitric acid, sulfuric acid, or another oxidizing acid.

In one or more embodiments, a method for preparing an anode carbon material is provided and includes combining a liquid refinery hydrocarbon product, such as petroleum product, and a solvent to produce a first mixture and combining the first mixture and a first oxidizing agent containing an acid to produce a second mixture containing the liquid refinery hydrocarbon product, such as petroleum product, the solvent, and the first oxidizing agent. The method further includes heating the second mixture to produce a reaction mixture containing an oxidized solid product during an oxidation process. The method also includes separating the oxidized solid product from the reaction mixture during a separation process and carbonizing the oxidized solid product to produce a hard carbon product during a carbonization process.

In other embodiments, a method for preparing an anode carbon material is provided and includes combining a first mixture and a first oxidizing agent containing an acid to produce a second mixture containing a liquid refinery hydrocarbon product, a solvent, and the first oxidizing agent. The first mixture has a weight ratio of the solvent to the liquid refinery hydrocarbon product of about 2 to about 10. The method further includes heating the second mixture to produce a reaction mixture containing an oxidized solid product during an oxidation process. The method also includes combining an additional amount of the solvent to the reaction mixture, separating the oxidized solid product from the reaction mixture during a separation process, and carbonizing the oxidized solid product to produce a hard carbon product during a carbonization process.

In some embodiments, a method for preparing an anode carbon material is provided and includes combining a first mixture and a first oxidizing agent containing an acid to produce a second mixture containing a liquid refinery hydrocarbon product, a solvent, and the first oxidizing agent. The first mixture contains the solvent and the liquid refinery hydrocarbon product, and the acid can be or include nitric acid or sulfuric acid. The method further includes heating the second mixture to produce a reaction mixture containing an oxidized solid product during an oxidation process, where the oxidized solid product contains at least 15 wt % of oxygen. The method also includes separating the oxidized solid product from the reaction mixture during a separation process and carbonizing the oxidized solid product to produce a hard carbon product during a carbonization process.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawing. It is to be noted, however, that the appended drawings illustrate only exemplary embodiments and are therefore not to be considered limiting of its scope, may admit to other equally effective embodiments.

FIG. 1 is a flowchart illustrating a method for preparing anode carbon materials, according to one or more embodiments described and discussed herein.

FIG. 2 is an illustrative schematic of a system which can be used for preparing anode carbon materials, according to one or more embodiments described and discussed herein.

FIGS. 3A-3C are graphs showing xylene insoluble yield, carbonization yield, and total carbon yield of various products prepared by methods described and discussed herein.

FIG. 4 is a graph showing oxygen content of various products prepared by methods described and discussed herein.

FIG. 5 is a graph showing X-ray diffraction pattern of hard carbon product prepared by methods described and discussed herein.

FIGS. 6A-6B are graphs showing a first charge/discharge cycle profile and a differential capacity for a hard carbon product prepared by methods described and discussed herein.

FIGS. 7A-7C are graphs showing a comparison of the first cycle discharging capacities, the charging capacities, and the first cycle efficiencies of hard carbon products prepared by methods described and discussed herein.

FIG. 8 is a graph showing a comparison of X-ray diffraction patterns of hard carbon products prepared from different acids by methods described and discussed herein.

FIGS. 9A-9B are graphs showing a first cycle profile and a voltage profile comparing carbon products prepared from different acids by methods described and discussed herein.

FIGS. 10A-10B are graphs showing X-ray diffraction patterns and calculated d(002) spacing of carbon products prepared by methods described and discussed herein.

FIGS. 11A-11B are graphs showing first cycle performances of carbon products prepared by methods described and discussed herein.

FIGS. 12A-12C are graphs showing plots of total reversible capacity and first cycle efficiency as a function of temperature, plots of the breakdown of total capacity into slopping capacity and plateau capacity, and plots correlation of d(002) with slopping capacity for carbon products prepared by methods described and discussed herein.

FIGS. 13A-13B are graphs showing and comparing the differential capacity of first cycle and second cycle of hard carbon products prepared at different temperatures by methods described and discussed herein.

FIGS. 14A-14B are graphs showing oxygen content and crystal structures of hard carbon products prepared at different temperatures by methods described and discussed herein.

FIGS. 15A-15C are graphs showing a first cycle charge/discharge profile, a first cycle efficiency (FCE), and a breakdown of total capacity into chateau and sloping capacities for batteries containing carbon products prepared by methods described and discussed herein.

FIG. 16 is a graph showing a first cycle charge/discharge capacity as a function of oxidation for batteries containing carbon products prepared by methods described and discussed herein.

FIG. 17 is a graph showing plots of reversible capacity and carbon yield as a function of temperature during a second oxidation process while preparing carbon products by methods described and discussed herein.

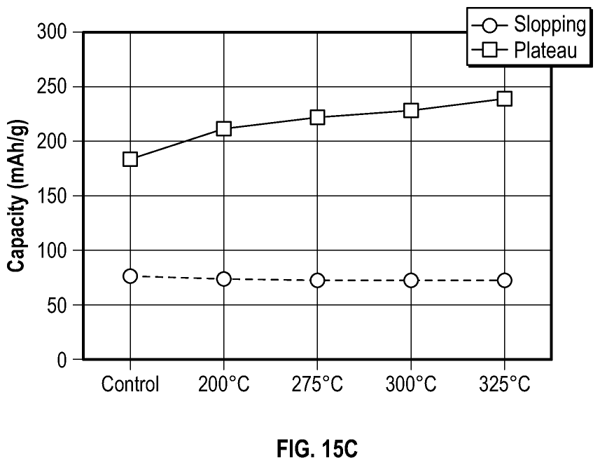

FIG. 18 is a graph showing a performance comparison of hard carbon prepared by methods described and discussed herein.

FIG. 19 is a graph showing a performance comparison of hard carbon prepared by methods described and discussed herein.

To facilitate understanding, identical reference numerals have been used, where possible, to designate identical elements that are common to the Figures. It is contemplated that elements and features of one or more embodiments may be beneficially incorporated in other embodiments.

### DETAILED DESCRIPTION

Embodiments of the present disclosure generally relate to methods for preparing carbon materials which can be used in battery electrodes, such as anodes. The anode carbon materials can be prepared or otherwise produced from heavy hydrocarbon streams and an oxidizing agent containing an acid. The heavy hydrocarbon streams can include polyaromatic hydrocarbons, such as a fluid catalytic cracking (FCC) slurry oil, and the oxidizing agent can contain nitric acid, sulfuric acid, or another oxidizing acid. The methods described and discussed herein produce carbon materials with a greater yield while being faster and more efficient than traditional methods for preparing similar carbon materials. In some examples, the method can be performed with a single oxidation process to produce the oxidized solid product which can be further exposed to a carbonization process to produce hard carbon products.

In one embodiment, a method is taught for preparing an anode carbon material, comprising combining a liquid refinery hydrocarbon product and a solvent to produce a first mixture. The method proceeds by combining the first mixture and a first oxidizing agent comprising an acid to produce a second mixture comprising the liquid refinery hydrocarbon product, the solvent, and the first oxidizing agent. Additionally, in this method the second mixture is heated to produce a reaction mixture comprising an oxidized solid product during an oxidation process. The method then separates the oxidized solid product from the reaction mixture during a separation process; and carbonizes the oxidized solid product to produce a hard carbon product during a carbonization process.

In one embodiment, the second mixture is heated to a process temperature of about 100° C. to about 200° C. during the oxidation process. As an embodiment, the separation process can further comprises adding an additional amount of the solvent to the reaction mixture; and filtering the oxidized solid product from the solvent.

In another embodiment, the oxidized solid product comprises at least 15 wt % of oxygen. In yet another embodiment, the liquid refinery hydrocarbon product comprises a fluid catalytic cracking (FCC) slurry oil, a heavy hydrocarbon stream comprising polyaromatic hydrocarbons, a coker gas oil, a vacuum gas oil, or any combination thereof. In another embodiment, the solvent comprises xylene, toluene, benzene, pyridine, mesitylene, benzyl alcohol, benzonitrile, nitrobenzene, one or more halo-aromatic compounds, or any combination thereof.

In one embodiment, the first mixture has a weight ratio of the solvent to the liquid refinery hydrocarbon product of about 2 to about 10. In yet another embodiment, the separating of the oxidized solid product from the reaction mixture comprises skimming or filtering the oxidized solid product from the reaction mixture. In one embodiment, the first oxidizing agent comprises nitric acid, sulfuric acid, chlorous acid, chloric acid, perchloric acid, chromic acid, derivatives thereof, salts thereof, or any combination thereof.

In one embodiment, the first oxidizing agent comprises sulfuric acid or nitric acid at a concentration of about 50 weight percent (wt %) or greater. In yet another embodiment the carbonization process comprises heating the oxidized solid product at a temperature of about 1,000° C. to about 3,000° C. for about 1 minute to about 10 hours. In another embodiment, after the separation process and before the carbonization process, further comprising exposing the oxidized solid product to a second oxidizing agent during a second oxidizing process.

It is also possible in one embodiment, that the second oxidizing agent comprises air, oxygen (O₂), or a combination thereof.

In one method for preparing an anode carbon material, the method can comprise: combining a first mixture and a first oxidizing agent comprising an acid to produce a second mixture comprising a liquid refinery hydrocarbon product, a solvent, and the first oxidizing agent, wherein the first mixture has a weight ratio of the solvent to the liquid refinery hydrocarbon product of about 2 to about 10. In this method the second mixture can be heated to produce a reaction mixture comprising an oxidized solid product during an oxidation process. It is also possible in this method to combine an additional amount of the solvent to the reaction mixture. The oxidized solid product can be separated from the reaction mixture during a separation process; and the oxidized solid product carbonized to produce a hard carbon product during a carbonization process.

In one embodiment, the second mixture is heated to a process temperature of about 100° C. to about 200° C. during the oxidation process. In yet another embodiment, the oxidized solid product comprises at least 15 wt % of oxygen. In another embodiment, the liquid refinery hydrocarbon product comprises a fluid catalytic cracking (FCC) slurry oil, a heavy hydrocarbon stream comprising polyaromatic hydrocarbons, a coker gas oil, a vacuum gas oil, or any combination thereof, and wherein the solvent comprises xylene, toluene, benzene, pyridine, mesitylene, benzyl alcohol, benzonitrile, nitrobenzene, one or more halo-aromatic compounds, or any combination thereof. In yet another embodiment, the first oxidizing agent comprises nitric acid, sulfuric acid, chlorous acid, chloric acid, perchloric acid, chromic acid, derivatives thereof, salts thereof, or any combination thereof, and wherein the first oxidizing agent comprises sulfuric acid or nitric acid at a concentration of about 50 weight percent (wt %) or greater.

In one embodiment a method for preparing an anode carbon material comprises: combining a first mixture and a first oxidizing agent comprising an acid to produce a second mixture comprising a liquid refinery hydrocarbon product, a solvent, and the first oxidizing agent, wherein the first mixture comprises the solvent and the liquid refinery hydrocarbon product, and the acid comprises nitric acid or sulfuric acid. This method then heats the second mixture to produce a reaction mixture comprising an oxidized solid product during an oxidation process, wherein the oxidized solid product comprises at least 15 wt % of oxygen. The oxidized solid product is then separated from the reaction mixture during a separation process. Finally, the oxidized solid product can be carbonized to produce a hard carbon product during a carbonization process.

In one embodiment, the second mixture is heated to a process temperature of about 100° C. to about 200° C. during the oxidation process. In another embodiment, the liquid refinery hydrocarbon product comprises a fluid catalytic cracking (FCC) slurry oil, a heavy hydrocarbon stream comprising polyaromatic hydrocarbons, a coker gas oil, a vacuum gas oil, or any combination thereof, and wherein the solvent comprises xylene, toluene, benzene, pyridine, mesitylene, benzyl alcohol, benzonitrile, nitrobenzene, one or more halo-aromatic compounds, or any combination thereof. In yet another embodiment, the first oxidizing agent comprises sulfuric acid or nitric acid at a concentration of about 50 weight percent (wt %) or greater.

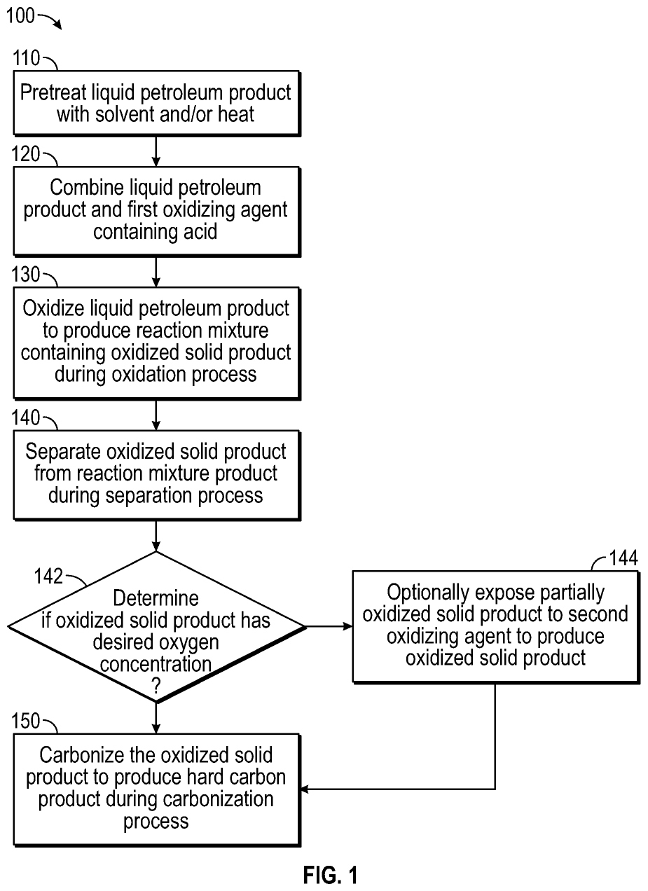

FIG. 1 is a flowchart illustrating a method 100 containing operations 110-150 for preparing anode carbon materials, according to one or more embodiments described and discussed herein. At operation 110, a liquid refinery hydrocarbon product can be pretreated to increase the viscosity. The pretreatment process can include diluting the liquid refinery hydrocarbon product with one or more solvents in a dilution process and/or heating the liquid refinery hydrocarbon product to a desired temperature. At operation 120, a first oxidizing agent containing one or more acids is combined with the liquid refinery hydrocarbon product and the solvent. At operation 130, the liquid refinery hydrocarbon product is oxidized to produce a reaction mixture containing an oxidized solid product during an oxidation process. At operation 140, the oxidized solid product is separated from the reaction mixture during a separation process. At operation 142, it is determined if the oxidized solid product has the desired oxygen concentration. If the oxidized solid product does not have the desired oxygen concentration, then the oxidized solid product proceeds to operation 144. If the oxidized solid product has the desired oxygen concentration, then the oxidized solid product proceeds to operation 150. At operation 144, a partially oxidized solid product is exposed to an additional oxidizing agent during a second oxidizing process to produce the oxidized solid product. At operation 150, the oxidized solid product is carbonized to produce a hard carbon product during a carbonization process.

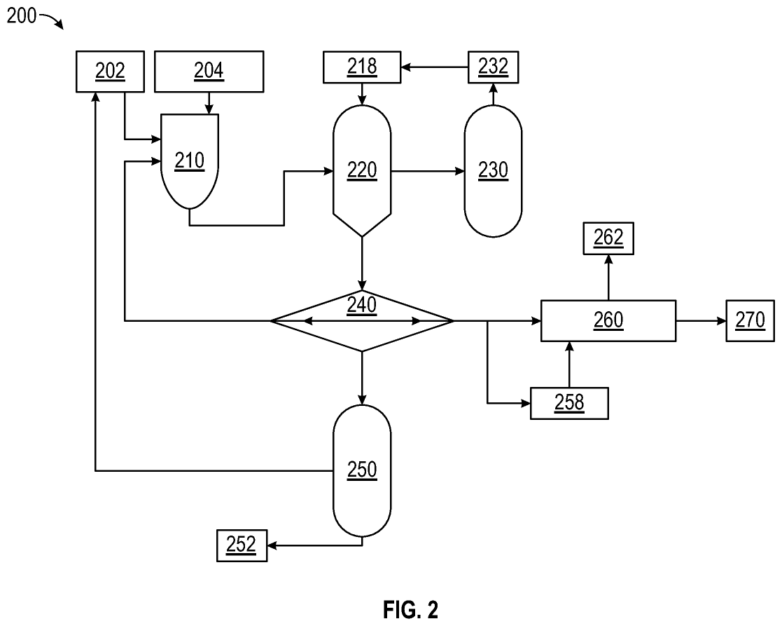

FIG. 2 is an illustrative schematic of a system 200 which can be used for preparing anode carbon materials, according to one or more embodiments described and discussed herein. In one or more embodiments, the system 200 can be utilized to perform the method 100 while preparing anode carbon materials. The system 200 can also be utilized to perform variations of the method 100, as well as other methods and processes to prepare various anode carbon materials.

At operation 110, one or more liquid refinery hydrocarbon products and one or more solvents are combined to produce a first mixture containing the liquid refinery hydrocarbon product and the solvent during a dilution process, according to one or more embodiments. A source 202 containing the solvent and a source 204 containing the liquid refinery hydrocarbon product can be fluidly coupled to a vessel 210, as depicted in FIG. 2. Each of the sources 202, 204 can independently be or include a vessel, a vat, a basin, a tank, a pipe, a process line, or another type of container or supply of the precursor.

The liquid refinery hydrocarbon product can be or include any type of hydrocarbon which can be oxidized to form the oxidized solid product. The liquid refinery hydrocarbon product can be selected from the liquid components that are produced from a fluid catalytic cracking (FCC) unit, a coking reactor, ethylene cracking, coal coking, or even a distillation tower. The liquid refinery hydrocarbon product can be or include one or more FCC slurry oils, one or more heavy hydrocarbon streams containing polyaromatic hydrocarbons, one or more coker gas oils from a coking process, one or more vacuum gas oils from vacuum distillation, one or more ethylene tars or cracking fluids, one or more coal tars, or any combination thereof. Typically, an FCC unit is used to convert high-boiling point, high molecular weight hydrocarbons into other products, such as FCC slurry oils. In one or more examples, the FCC slurry oil has a boiling point of about 500° F. to about 1,300° F., an average molecular weight of about 100 to about 400, and an average number of aromatic rings of 2 to about 10. The FCC slurry oil is generally defined as lower viscosity, catalytic-cracked clarified oil that generally has a viscosity of about 48 cST to about 200 cST @ 122° F. In other examples, the FCC slurry oil has an average molecular weight of greater than 400 to about 600 and an average number of aromatic rings greater than 10 to about 20.

The solvent can be or include any solvent or combination of solvents which the oxidized solid product is relatively insoluble in so that the oxidized solid product can be later readily removed from the reaction mixture. The solvent can be or include xylene, toluene, benzene, pyridine, mesitylene, benzyl alcohol, benzonitrile, nitrobenzene, one or more halo-aromatic compounds, one or more alkanes, or any combination thereof. Exemplary halo-aromatic compounds can be or include chlorobenzene, dichlorobenzene, difluorobenzene, hexafluorobenzene, trichlorobenzene, trifluorotoluene, or any combination thereof. In one or more examples, the solvent is or includes xylene.

The solvent can be flowed or otherwise transferred from the source 202 into the vessel 210 and the liquid refinery hydrocarbon product can be flowed or otherwise transferred from the course 204 into the vessel 210. The liquid refinery hydrocarbon product can be dissolved or otherwise diluted by the solvent and mixed to produce the first mixture. The liquid refinery hydrocarbon product and the solvent can be mixed, blended, or otherwise combined by any physical agitation or turbulence within the vessel 210.

In one or more embodiments, the first mixture contains a concentration or amount of the solvent relative to the liquid refinery hydrocarbon product at a weight ratio from a minimum value of about 1, about 2, about 3, about 4, or about 5 to a maximum value of about 6 about 7, about 8, about 9, about 10, about 12, about 15, about 18, about 20, about 25, about 30, or more. For example, the first mixture has a weight ratio of the solvent to the liquid refinery hydrocarbon product of about 1 to about 30, about 1 to about 20, about 1 to about 15, about 1 to about 12, about 1 to about 10, about 1 to about 8, about 1 to about 6, about 1 to about 5, about 1 to about 4, about 1 to about 2, about 2 to about 30, about 2 to about 20, about 2 to about 15, about 2 to about 12, about 2 to about 10, about 2 to about 8, about 2 to about 6, about 2 to about 5, about 2 to about 4, about 4 to about 30, about 4 to about 20, about 4 to about 15, about 4 to about 12, about 4 to about 10, about 4 to about 8, about 4 to about 6, about 8 to about 30, about 8 to about 20, about 8 to about 15, about 8 to about 12, or about 8 to about 10.

Also at operation 110, the pretreatment process can include heating the liquid refinery hydrocarbon product to a desired temperature. In some examples, the liquid refinery hydrocarbon product can be heated in the source 204 and/or in the vessel 210. In one or more examples, the solvent can be heated in the source 202, then used to heat the liquid refinery hydrocarbon product once combined within the vessel 210. Each of the liquid refinery hydrocarbon product, the solvent, and the first mixture can independently be heated to a temperature having a minimum value of about 25° C., about 50° C., about 80° C., or about 100° C. to a maximum value of about 120° C., about 150° C., about 180° C., about 200° C., or greater. For example, each of the liquid refinery hydrocarbon product, the solvent, and the first mixture can independently be heated to a temperature of about 25° C. to about 200° C., about 50° C. to about 180° C., about 65° C. to about 150° C., or about 80° C. to about 120° C.

At operation 120, the first mixture containing the liquid refinery hydrocarbon product and the solvent can be transferred from the vessel 210 to a vessel 220. A source 218 of a first oxidizing agent containing one or more acids (e.g., nitric acid or sulfuric acid) is fluidly coupled to the vessel 220. The first oxidizing agent can be transferred from the source 218 into the vessel 220 and combined with the first mixture to produce a second mixture which contains the liquid refinery hydrocarbon product, the solvent, and the first oxidizing agent. Each of the vessels 210, 220 can independently be or include a vat, a basin, a chamber, a reactor, a tank, a pipe, a process line, or another type of container. The source 218 can be or include a vessel, a vat, a basin, a tank, a pipe, a process line, or another type of container.

The first oxidizing agent and the liquid refinery hydrocarbon product can be combined at various ratio amounts depending on the types and concentrations of each of the first oxidizing agent and the liquid refinery hydrocarbon product. In one or more embodiments, the second mixture contains the first oxidizing agent (e.g., the acid) relative to the liquid refinery hydrocarbon product at a weight ratio from a minimum value of about 0.1:1, about 0.2:1, about 0.3:1, about 0.4:1, or about 0.5:1 to a maximum value of about 0.6:1, about 0.7:1, about 0.8:1, about 0.9:1, about 1:1, about 1.1:1, about 1.2:1, about 1.5:1, or greater. For example, the second mixture contains the first oxidizing agent (e.g., the acid) relative to the liquid refinery hydrocarbon product at a weight ratio of about 0.1:1 to about 1.5:1, about 0.2:1 to about 1.5:1, about 0.4:1 to about 1.5:1, about 0.5:1 to about 1.5:1, about 0.6:1 to about 1.5:1, about 0.7:1 to about 1.5:1, about 0.8:1 to about 1.5:1, about 1:1 to about 1.5:1, about 1.2:1 to about 1.5:1, about 0.1:1 to about 1:1, about 0.2:1 to about 1:1, about 0.4:1 to about 1:1, about 0.5:1 to about 1:1, about 0.6:1 to about 1:1, about 0.7:1 to about 1:1, about 0.8:1 to about 1:1, about 0.1:1 to about 0.8:1, about 0.2:1 to about 0.8:1, about 0.4:1 to about 0.8:1, about 0.5:1 to about 0.8:1, or about 0.6:1 to about 0.8:1.

The first oxidizing agent contains one or more acids, such as one or more oxidizing acids. The acid is a strong enough oxidizer in order to oxidizing the liquid refinery hydrocarbon product while forming the oxidized solid product. Exemplary acids which can be used as or in the first oxidizing agent can be or include nitric acid, sulfuric acid, aqua regia, chromic acid, periodic acid, permanganic acid, chlorous acid, chloric acid, perchloric acid, hypochlorous acid, iodic acid, hypoiodous acid, hypobromous acid, perbromic acid, derivatives thereof, salts thereof, or any combination thereof. In some examples, the first oxidizing agent can be or include nitric acid or sulfuric acid at a concentration of about 50 weight percent (wt %) or greater. For example, the acid can be highly concentrated to be a fuming acid, such as 70% nitric acid (about 70 weight percent (wt %) nitric acid, remainder water) or 98% sulfuric acid (about 98 wt % sulfuric acid, remainder water).

In one or more embodiments, the first oxidizing agent contains the acid at a concentration of about 20 wt % or greater. For example, the first oxidizing agent contains the acid at a concentration from a minimum value of about 22 wt %, about 25 wt %, about 30 wt %, about 35 wt %, about 40 wt %, or about 50 wt % to a maximum value of about 55 wt %, about 60 wt %, about 70 wt %, about 80 wt %, about 90 wt %, about 95 wt %, about 98 wt %, about 99 wt %, or about 100 wt %. For example, the first oxidizing agent contains the acid at a concentration of about 20 wt % to about 100 wt %, about 25 wt % to about 100 wt %, about 30 wt % to about 100 wt %, about 40 wt % to about 100 wt %, about 50 wt % to about 100 wt %, about 60 wt % to about 100 wt %, about 70 wt % to about 100 wt %, about 80 wt % to about 100 wt %, about 90 wt % to about 100 wt %, about 95 wt % to about 100 wt %, about 20 wt % to about 85 wt %, about 25 wt % to about 85 wt %, about 30 wt % to about 85 wt %, about 40 wt % to about 85 wt %, about 50 wt % to about 85 wt %, about 60 wt % to about 85 wt %, about 70 wt % to about 85 wt %, about 80 wt % to about 85 wt %, about 20 wt % to about 65 wt %, about 25 wt % to about 65 wt %, about 30 wt % to about 65 wt %, about 40 wt % to about 65 wt %, or about 50 wt % to about 65 wt %. In one or more examples, the acid can be or include nitric acid or sulfuric acid at a concentration of about 50 wt % or greater, such as about 70 wt % to about 100 wt %.

In other embodiments, the first oxidizing agent contains the acid at a concentration of greater than 1 molarity (M), such as that the first oxidizing agent contains the acid at a concentration from a minimum value of about 1.2 M, about 1.5 M, about 2 M, about 3 M, about 5 M, about 7 M, about 8 M, or about 10 M to a maximum value of about 12 M, about 14 M, about 15 M, about 16 M, about 18 M, about 20 M, about 25 M, or greater. For example, the first oxidizing agent contains the acid at a concentration of greater than 1 to about 25 M, greater than 1 to about 20 M, greater than 1 to about 18 M, greater than 1 to about 16 M, greater than 1 to about 15 M, greater than 1 to about 12 M, greater than 1 to about 10 M, greater than 1 to about 8 M, greater than 1 to about 5 M, about 5 to about 25 M, about 5 to about 20 M, about 5 to about 18 M, about 5 to about 16 M, about 5 to about 15 M, about 5 to about 12 M, about 5 to about 10 M, about 5 to about 8 M, about 10 to about 25 M, about 10 to about 20 M, about 10 to about 18 M, about 10 to about 16 M, about 10 to about 15 M, or about 10 to about 12 M. In one or more examples, the acid can be or include sulfuric acid or nitric acid at a concentration of about 5 M or greater, such as about 6 M to about 18 M or about 8 M to about 16 M.

At operation 130, the second mixture containing the liquid refinery hydrocarbon product, the solvent, and the first oxidizing agent is heated to produce a reaction mixture containing an oxidized solid product during the oxidation process. The second mixture can be heated within the vessel 220 during the oxidation process. The second mixture can be heated at the process temperature for a time period having a minimum time of about 5 minutes, about 10 minutes, about 15 minutes, or about 20 minutes to about 30 minutes, about 45 minutes, about 60 minutes, about 75 minutes, about 90 minutes, about 120 minutes, about 150 minutes, or longer. For example, the second mixture can be heated at the process temperature for about 5 minutes to about 150 minutes, about 5 minutes to about 120 minutes, about 5 minutes to about 90 minutes, about 5 minutes to about 75 minutes, about 5 minutes to about 60 minutes, about 5 minutes to about 45 minutes, about 5 minutes to about 30 minutes, about 5 minutes to about 20 minutes, about 5 minutes to about 15 minutes, about 5 minutes to about 10 minutes, about 15 minutes to about 150 minutes, about 15 minutes to about 120 minutes, about 15 minutes to about 90 minutes, about 15 minutes to about 75 minutes, about 15 minutes to about 60 minutes, about 15 minutes to about 45 minutes, about 15 minutes to about 30 minutes, about 15 minutes to about 20 minutes, about 30 minutes to about 150 minutes, about 30 minutes to about 120 minutes, about 30 minutes to about 90 minutes, about 30 minutes to about 75 minutes, about 30 minutes to about 60 minutes, or about 30 minutes to about 45 minutes.

The second mixture can be heated to a process temperature having a minimum value of about 30° C., about 50° C., about 80° C., about 100° C., about 120° C., about 130° C., about 140° C., or about 150° C. to a maximum value of about 160° C., about 170° C., about 180° C., about 190° C., about 200° C., about 220° C., about 235° C., or about 250° C. during the oxidation process. For example, the second mixture can be heated to a process temperature about 50° C. to about 250° C., about 100° C. to about 250° C., about 100° C. to about 220° C., about 100° C. to about 200° C., about 100° C. to about 180° C., about 100° C. to about 160° C., about 100° C. to about 150° C., about 100° C. to about 140° C., about 100° C. to about 120° C., about 120° C. to about 250° C., about 120° C. to about 220° C., about 120° C. to about 200° C., about 120° C. to about 180° C., about 120° C. to about 160° C., about 120° C. to about 150° C., about 120° C. to about 140° C., about 130° C. to about 250° C., about 130° C. to about 220° C., about 130° C. to about 200° C., about 130° C. to about 180° C., about 130° C. to about 160° C., about 130° C. to about 150° C., or about 130° C. to about 140° C. during the oxidation process.

During the oxidation process, excess acid from the first oxidizing agent can be vaporized or distilled from the vessel 220 and transported to a process unit 230 which includes a condensation unit and/or a regeneration unit, as depicted in FIG. 2. The acid (e.g., nitric acid or sulfuric acid) can be condensed, purified, concentrated, filtered, or otherwise regenerated in the process unit 230. Thereafter, the regenerated acid can be transported to a storage vessel 232 and/or transported back to the source 218 of the first oxidizing agent.

At operation 140, the oxidized solid product can be isolated or otherwise separated from the rest of the reaction mixture during a separation process. The reaction mixture can be transferred from the vessel 220 to a separation unit 240, as depicted in FIG. 2. The separation unit 240 can be or include a filter, a skimmer, or other device for separating the oxidized solid product from the remaining reaction mixture.

The reaction mixture contains the oxidized solid product, as well as one or more byproducts, the solvent, unreacted components of the liquid refinery hydrocarbon product, and/or unreacted components of the first oxidizing agent (e.g., acid). Additional solvent (e.g., xylene) can be added into the reaction mixture to precipitate the oxidized solid product and facilitate the removal or separation of dissolved compound and/or products away from the oxidized solid product. In some examples, the separation process includes introducing additional amount of the solvent to the reaction mixture before filtering or otherwise separating the oxidized solid product from the solvent. In one or more embodiments, one or more solvents can be added to the reaction mixture until a precipitated product which is insoluble in the solvent is crashed out from the reaction mixture. The precipitated product can be or include the oxidized solid product. The solvent can be added to the reaction mixture at weight ratio of the solvent relative to the liquid refinery hydrocarbon product of about 1:1 to about 5:1, such as about 1.5:1 to about 4:1, or about 2:1 to about 3:1.

The oxidized solid product can be filtered, skimmed, or otherwise separated from the reaction mixture with the separation unit 240. In one or more examples, the oxidized solid product can be filtered from the reaction mixture. In one or more examples, the oxidized solid product is less dense than the reaction mixture and can float at or near the top surface of the reaction mixture. A skimmer or other device can be used to skim or gather the oxidized solid product from the reaction mixture. In some examples, the reaction mixture and/or the remaining portion of the first oxidizing agent can be decanted from the oxidized solid product. During and/or post the separating the oxidized solid product from the reaction mixture, the oxidized solid product can be rinsed with the solvent to remove contaminants or other impurities. For example, the oxidized solid product can be rinsed with xylene or another solvent to remove xylene dissolvable impurities. The solvent can be at room temperature (e.g., about 23° C.) or heated up to boiling temperature.

In one or more embodiments, the separation unit 240 is fluidly coupled to the vessel 220 and configured to receive the reaction mixture from the vessel 220. The separated components of the reaction mixture can be transported to a variety of other portions of the system 200. A liquid stream containing the solvent can be transported from the separation unit 240 to the vessel 210 to be recycled and combined with the first mixture containing the liquid refinery hydrocarbon product and the solvent. If the liquid stream has too many impurities or not enough of the solvent, the liquid stream can be transported to a separator or fractionator 250, which is fluidly coupled to the separation unit 240. The fractionator 250 further removes solvent from the stream received from the separation unit 240 and produces a solvent stream and a waste stream. The fractionator 250 is fluidly coupled to the source 202 via the solvent stream so that recovered solvent can be transported and combined with the solvent in the source 202. The fractionator 250 is fluidly coupled to the storage 252 via the waste stream so that recovered waste can be transported and placed into in the storage 252 which can be later discarded or recycled.

In one or more embodiments, the oxidized solid product contains at least 15 wt % of oxygen. The oxidized solid product contains oxygen at a concentration from a minimum value of 15 wt %, about 16 wt %, about 18 wt %, about 20 wt %, about 24 wt %, about 25 wt % or about 26 wt % to a maximum value of about 27 wt %, about 28 wt %, about 30 wt %, about 32 wt %, about 35 wt %, about 38 wt %, about 40 wt %, or more. For example, the oxidized solid product contains oxygen at a concentration of at least 15 wt % to about 40 wt %, at least 15 wt % to about 38 wt %, at least 15 wt % to about 35 wt %, at least 15 wt % to about 32 wt %, at least 15 wt % to about 30 wt %, at least 15 wt % to about 27 wt %, at least 15 wt % to about 25 wt %, at least 15 wt % to about 23 wt %, at least 15 wt % to about 22 wt %, at least 15 wt % to about 20 wt %, at least 15 wt % to about 18 wt %, about 20 wt % to about 40 wt %, about 20 wt % to about 38 wt %, about 20 wt % to about 35 wt %, about 20 wt % to about 32 wt %, about 20 wt % to about 30 wt %, about 20 wt % to about 27 wt %, about 20 wt % to about 25 wt %, about 20 wt % to about 23 wt %, about 20 wt % to about 22 wt %, about 22 wt % to about 40 wt %, about 22 wt % to about 38 wt %, about 22 wt % to about 35 wt %, about 22 wt % to about 32 wt %, about 22 wt % to about 30 wt %, about 22 wt % to about 27 wt %, about 22 wt % to about 25 wt %, about 22 wt % to about 23 wt %, about 25 wt % to about 40 wt %, about 25 wt % to about 38 wt %, about 25 wt % to about 35 wt %, about 25 wt % to about 32 wt %, about 25 wt % to about 30 wt %, about 25 wt % to about 27 wt %, about 28 wt % to about 40 wt %, about 28 wt % to about 38 wt %, about 28 wt % to about 35 wt %, about 28 wt % to about 32 wt %, or about 28 wt % to about 30 wt %.

The oxidized solid product can have an average particle size of less than 150 μm, such as an average particle size having a minimum value of about 1 μm, about 5 μm, about 10 μm, about 15 μm, or about 18 μm to a maximum value of about 20 μm, about 25 μm, about 30 μm, about 40 μm, about 50 μm, about 70 μm, about 85 μm, about 100 μm, about 120 μm, about 135 μm, or less than 150 μm. For example, the oxidized solid product can have an average particle size of about 1 μm to less than 150 μm, about 5 μm to about 135 μm, about 5 μm to about 120 μm, about 5 μm to about 100 μm, about 5 μm to about 180 μm, about 5 μm to about 50 μm, about 5 μm to about 35 μm, about 5 μm to about 30 μm, about 5 μm to about 25 μm, about 5 μm to about 20 μm, about 5 μm to about 15 μm, about 5 μm to about 10 μm, about 10 μm to about 120 μm, about 10 μm to about 100 μm, about 10 μm to about 180 μm, about 10 μm to about 50 μm, about 10 μm to about 35 μm, about 10 μm to about 30 μm, about 10 μm to about 25 μm, about 10 μm to about 20 μm, about 10 μm to about 15 μm, about 10 μm to about 12 μm, about 15 μm to about 25 μm, about 15 μm to about 35 μm, about 15 μm to about 50 μm, about 15 μm to about 100 μm, about 20 μm to about 120 μm, about 20 μm to about 100 μm, about 20 μm to about 180 μm, about 20 μm to about 50 μm, about 20 μm to about 35 μm, about 20 μm to about 30 μm, or about 20 μm to about 25 μm.

At operation 142, it is determined if the oxidized solid product has the desired oxygen concentration, such as 20 wt % or greater of oxygen. A partially oxidized solid product has an oxygen concentration of less than 20 wt %, such as about 1 wt % to about 18 wt % or about 19 wt %. If the partially oxidized solid product does not have the desired oxygen concentration, then the partially oxidized solid product proceeds to an additional or second oxidation process at operation 144. If the oxidized solid product has the desired oxygen concentration, then the oxidized solid product proceeds to the carbonization process at operation 150.

In one or more embodiments, the separation unit 240 is coupled to a vessel 260, such as a furnace or other chamber or reactor for conducting the carbonization process. The oxidized solid product is delivered to the vessel 260 from the separation unit 240. In another embodiment, if a second or additional oxidation process is desired, the separation unit 240 can be coupled to a vessel 258 for conducting the second or additional oxidation process. The partially oxidized solid product is delivered to the vessel 258 from the separation unit 240. The partially oxidized solid product is oxidized within the vessel 258 to produce the oxidized solid product. Thereafter, the oxidized solid product is transferred to the vessel 260, which is coupled to the vessel 258, before being exposed to the carbonization process.

At operation 144, the partially oxidized solid product can be exposed to an additional or second oxidizing agent during a second oxidizing process to produce the oxidized solid product. For example, after the separation process and before the carbonization process, the partially oxidized solid product is exposed to the second oxidizing agent during the second oxidizing process. The partially oxidized solid product and the second oxidizing agent can be combined and heated to produce the second oxidized solid product during the second oxidation process. The second oxidizing agent can be or include one or more oxygen-containing sources or compounds which further oxidize the partially oxidized solid product during the second oxidation process. The second oxidizing agent can be in a fluid state, such as a gaseous state and/or a liquid state. The second oxidizing agent can be the same or different as the first oxidizing agent. The second oxidizing agent can be or include air, oxygen (O₂), ozone, atomic oxygen, nitric oxide, nitrous oxide, one or more oxidizing acids (e.g., nitric acid), water, hydrogen peroxide, one or more alkaline peroxides (e.g., calcium peroxide), one or more organic peroxides, salts thereof, or any combination thereof. In one or more examples, the second oxidizing agent can be or include air, oxygen (O₂), oxygen enriched air, or any combination thereof.

In some examples, the second oxidizing agent flowed or otherwise exposed to the partially oxidized solid product within the vessel 258. In other examples, a reaction mixture of the partially oxidized solid product and the second oxidizing agent is contained within the vessel 258. The vessel 258 can be or include a furnace, a thermal chamber, a reactor, a tank, a pipe, or another type of container.

The partially oxidized solid product and/or the reaction mixture can be heated to a process temperature of about 200° C. or greater for about 1 minute to about 24 hours, such as about 1 hour to about 5 hours, during the second oxidation process. In some examples, the partially oxidized solid product and/or the reaction mixture can be heated to a process temperature having a minimum value of about 200° C., about 220° C., about 230° C., about 240° C., about 250° C., about 260° C., or about 275° C. to a maximum value of about 290° C., about 300° C., about 325° C., about 350° C., about 375° C., about 400° C., about 420° C., about 450° C., about 480° C., or about 500° C. during the second oxidation process. For example, the partially oxidized solid product and/or the reaction mixture can be heated to a process temperature of about 200° C. to about 500° C., about 200° C. to about 450° C., about 200° C. to about 400° C., about 200° C. to about 375° C., about 200° C. to about 350° C., about 200° C. to about 325° C., about 200° C. to about 300° C., about 200° C. to about 250° C., about 250° C. to about 500° C., about 250° C. to about 450° C., about 250° C. to about 400° C., about 250° C. to about 375° C., about 250° C. to about 350° C., about 250° C. to about 325° C., about 250° C. to about 300° C., about 250° C. to about 275° C., about 300° C. to about 500° C., about 300° C. to about 450° C., about 300° C. to about 400° C., about 300° C. to about 375° C., about 300° C. to about 350° C., or about 300° C. to about 325° C. during the second oxidation process.

At operation 150, the oxidized solid product is further processed to produce one or more hard carbon products during the carbonization process. For example, the oxidized solid product can be heated and carbonized to produce the hard carbon product during the carbonization process. The oxidized solid product can be heated and maintained under an atmosphere of a relatively inert gas (e.g., dinitrogen, argon, helium, or mixtures thereof) or can be maintained under a vacuum while producing the hard carbon product during the carbonization process.

In one or more embodiments, the oxidized solid product is heated to a temperature of about 800° C. or greater for about 1 hour to about 5 hours during the carbonization process to produce the hard carbon product used as the anode carbon material. The oxidized solid product is heated to a temperature from a minimum value of about 800° C., about 900° C., about 1,000° C., about 1,200° C., or about 1,400° C. to a maximum value of about 1,500° C., about 1,650° C., about 1,800° C., about 2,000° C., about 2,300° C., about 2,500° C., about 2,700° C., about 2,900° C., about 3,000° C., or greater during the carbonization process. For example, the oxidized solid product is heated to a temperature of about 800° C. to about 3,000° C., about 800° C. to about 2,500° C., about 800° C. to about 2,000° C., about 800° C. to about 1,800° C., about 800° C. to about 1,500° C., about 800° C. to about 1,000° C., about 1,000° C. to about 3,000° C., about 1,000° C. to about 2,900° C., about 1,000° C. to about 2,500° C., about 1,000° C. to about 2,200° C., about 1,000° C. to about 2,000° C., about 1,000° C. to about 1,800° C., about 1,000° C. to about 1,500° C., about 1,000° C. to about 1,200° C., about 1,400° C. to about 3,000° C., about 1,400° C. to about 2,500° C., about 1,400° C. to about 2,000° C., or about 1,400° C. to about 1,800° C. during the carbonization process.

In one or more examples, the carbonization process includes heating the oxidized solid product at a temperature of about 1,000° C. to about 3,000° C. for about 1 minute to about 10 hours to produce the hard carbon product. In other examples, the carbonization process includes heating the oxidized solid product at a temperature of about 1,200° C. to about 2,500° C. for about 1 hour to about 5 hours the hard carbon product. In some examples, the carbonization process includes heating the oxidized solid product at a temperature of about 1,500° C. to about 2,000° C. for about 2 hours to about 4 hours the hard carbon product.

The carbonization process can be performed in the vessel 260 (FIG. 2) which can be or include a furnace (e.g., graphitization furnace or carbonization furnace), a thermal chamber, a reactor, or another type of container. The vessel 260 can vent gaseous products (e.g., carbon dioxide) or other gaseous compounds to an exhaust 262. The hard carbon product can be transferred from the vessel 260 to a storage or other container 270.

The hard carbon product can have an average particle size of less than 150 μm, such as an average particle size having a minimum value of about 1 μm, about 5 μm, about 10 μm, about 15 μm, or about 18 μm to a maximum value of about 20 μm, about 25 μm, about 30 μm, about 40 μm, about 50 μm, about 70 μm, about 85 μm, about 100 μm, about 120 μm, about 135 μm, or less than 150 μm. For example, the hard carbon product can have an average particle size of about 1 μm to less than 150 μm, about 5 μm to about 135 μm, about 5 μm to about 120 μm, about 5 μm to about 100 μm, about 5 μm to about 180 μm, about 5 μm to about 50 μm, about 5 μm to about 35 μm, about 5 μm to about 30 μm, about 5 μm to about 25 μm, about 5 μm to about 20 μm, about 5 μm to about 15 μm, about 5 μm to about 10 μm, about 10 μm to about 120 μm, about 10 μm to about 100 μm, about 10 μm to about 180 μm, about 10 μm to about 50 μm, about 10 μm to about 35 μm, about 10 μm to about 30 μm, about 10 μm to about 25 μm, about 10 μm to about 20 μm, about 10 μm to about 15 μm, about 10 μm to about 12 μm, about 15 μm to about 25 μm, about 15 μm to about 35 μm, about 15 μm to about 50 μm, about 15 μm to about 100 μm, about 20 μm to about 120 μm, about 20 μm to about 100 μm, about 20 μm to about 180 μm, about 20 μm to about 50 μm, about 20 μm to about 35 μm, about 20 μm to about 30 μm, or about 20 μm to about 25 μm.

The method 100 for preparing the anode carbon material can include and/or omit different operations 110-150 and/or processes as described and discussed herein. In one or more examples, the method 100 can include combining the liquid refinery hydrocarbon product and the solvent to produce the first mixture (operation 110), combining the first mixture and the first oxidizing agent containing the acid to produce the second mixture containing the liquid refinery hydrocarbon product, the solvent, and the first oxidizing agent (operation 120), and heating the second mixture to produce the reaction mixture containing the oxidized solid product during the oxidation process (operation 130). The method 100 also includes separating the oxidized solid product from the reaction mixture during the separation process (operation 140) and carbonizing the oxidized solid product to produce the hard carbon product during the carbonization process (operation 150).

In other examples, the method 100 can include combining the first mixture and the first oxidizing agent containing the acid to produce the second mixture containing the liquid refinery hydrocarbon product, the solvent, and the first oxidizing agent (operation 120). The first mixture has the weight ratio of the solvent to the liquid refinery hydrocarbon product of about 2 to about 10. The method 100 also includes heating the second mixture to produce the reaction mixture containing the oxidized solid product during the oxidation process (operation 130). The method 100 also includes combining the additional amount of the solvent to the reaction mixture and separating the oxidized solid product from the reaction mixture during the separation process (operation 140), then carbonizing the oxidized solid product to produce the hard carbon product during the carbonization process (operation 150).

In some examples, the method 100 can include combining the first mixture and the first oxidizing agent containing the acid to produce the second mixture containing the liquid refinery hydrocarbon product, the solvent, and the first oxidizing agent (operation 120). The first mixture contains the solvent and the liquid refinery hydrocarbon product, and the acid can be or include nitric acid or sulfuric acid. The method 100 further includes heating the second mixture to produce the reaction mixture containing the oxidized solid product during the oxidation process (operation 130). The oxidized solid product contains at least 15 wt % of oxygen. The method 100 also includes separating the oxidized solid product from the reaction mixture during the separation process (operation 140) and carbonizing the oxidized solid product to produce the hard carbon product during the carbonization process (operation 150).

In one or more examples, the method 100 can include combining the liquid refinery hydrocarbon product and the solvent to produce the first mixture (operation 110) and combining the first mixture and the first oxidizing agent containing the acid to produce the second mixture containing the liquid refinery hydrocarbon product, the solvent, and the first oxidizing agent (operation 120). The method 100 can further include heating the second mixture to produce the reaction mixture containing the oxidized solid product during the oxidation process (operation 130) and separating the oxidized solid product from the reaction mixture during the separation process (operation 140). The method 100 can also include determining the oxidized solid product contains an undesirably low oxygen concentration (operation 142) and expose the partially oxidized solid product to a second oxidizing agent (e.g., air and/or O₂) during the second oxidation process to prepare the oxidized solid product (operation 144). The method 100 further includes carbonizing the oxidized solid product to produce the hard carbon product during the carbonization process (operation 150).

### Examples

In order to provide a better understanding of the foregoing discussion, the following non-limiting examples are offered. Although the examples can be directed to specific embodiments, they are not to be viewed as limiting the invention in any specific respect.

In one or more general examples, the hard carbon product can be produced from the liquid refinery hydrocarbon product during methods described and discussed herein. The liquid refinery hydrocarbon product containing a polyaromatic-containing liquid can be pre-heated to about 50° C. to about 75° C. and/or diluted with a solvent (e.g., xylene) to form a less-viscous liquid. The liquid refinery hydrocarbon product and the solvent are combined in a vessel to produce a first mixture. A concentrated acid (e.g., 70 wt % nitric acid or 98 wt % sulfuric acid) is added to the first mixture to produce a second mixture. The acid to slurry oil weight ratio is about 0.4:1 to about 0.8:1 within the second mixture. The second mixture is heated at a temperature of about 120° C. to about 170° C. for about 10 minutes to about 1 hour to produce a reaction mixture containing the oxidized solid product. Boiling xylene has added to the reaction mixture at a xylene to slurry oil weight ratio of 2:1 to precipitate the xylene insoluble solids (including the oxidized solid product) from the reaction mixture. The insoluble solids including the oxidized solid product were filtered from the reaction mixture, washed with xylene, and then dried. The oxidized solid product was heated in a graphitization furnace at a temperature of about 900° C. to about 2,000° C. for about 10 minutes to about 10 hours to produce the hard carbon product.

Examples 1-9: Hard carbon preparation—The heavy fraction (about 500+° C.) of slurry oils were used as feedstocks for preparing hard carbon products. For each of the Examples 1-9, the following process was performed: 1) fully dissolve the slurry oil in xylene to form a homogenous mixture; 2) heat the mixture to 65° C. in a silicon oil bath; 3) add a certain amount of 70% nitric acid into the mixture within 5 minutes; 4) heat the resulting mixture to the boiling point of xylene (140° C.-150° C.) to accelerate the reaction and evaporate the unreacted HNO₃; 5) in the case where initial xylene/slurry oil is less than 6, additional boiling xylene was added to the boiling mixture upon the completion of reaction to reach xylene/slurry ratio of 6, in order to fully precipitate the xylene insoluble products; 6) remove the heat and cool the mixture to the room temperature (about 23° C.); 7) filter the mixture, wash with xylene, collect and dry the solid powder; and 8) heat the resulting powder at a rate of 5° C./min to 1,400° C. and hold for two hours under a nitrogen atmosphere to complete carbonization. Table 1 provides additional details for Examples 1-9. Examples 1-3 are in Group 1, Examples 4-6 are in Group 2, and Examples 7-9 are in Group 3, as further discussed below.

TABLE 1

| | Slurry | Nitric | | Extra | XI | Carbonization | Total | Layer | Number |
|---|---|---|---|---|---|---|---|---|---|
| | oil | acid | Xylene | xylene | yield | yield | carbon yield | spacing | of |
| EX | (g) | (g) | (g) | (g) | (%) | (%) | (%) | (Å) | layers |
| 1 | 10 | 2 | 60 | 0 | 16.2 | 71.0 | 11.5 | 3.667 | 2.83 |
| 2 | 10 | 4 | 60 | 0 | 30.6 | 66.4 | 20.3 | 3.666 | 2.81 |
| 3 | 10 | 6 | 60 | 0 | 32.1 | 64.8 | 20.8 | 3.671 | 2.86 |
| 4 | 10 | 2 | 40 | 20 | 18.4 | 69.7 | 12.8 | 3.655 | 2.88 |
| 5 | 10 | 4 | 40 | 20 | 30.7 | 66.3 | 20.4 | 3.663 | 2.73 |
| 6 | 10 | 6 | 40 | 20 | 38.2 | 65.1 | 24.8 | 3.671 | 2.81 |
| 7 | 10 | 2 | 20 | 40 | 18.0 | 71.4 | 12.8 | 3.674 | 2.85 |
| 8 | 10 | 4 | 20 | 40 | 33.7 | 66.5 | 22.4 | 3.648 | 2.64 |
| 9 | 10 | 6 | 20 | 40 | 40.6 | 62.9 | 25.8 | 3.651 | 2.79 |

Two variables, xylene/slurry ratio and acid/slurry oil ratio, were studied at three levels (high, medium, and low). The matrix table is shown in Table 1. The carbon yield and battery performance for the slurry oil were determined and discussed below.

Material Characterization—CNHS analysis was used to measure the elemental composition of solid powder obtained in step (7), which is the oxidized product of slurry oil. X-ray diffraction (XRD) was employed to determine the d (002) spacing and Lc (002) of the hard carbon materials.

Sodium-ion battery evaluation—The electrode slurry consists of 90 wt % hard carbon, 5 wt % carbon black and 5 wt % PVDF binder. The slurry was fully mixed and coated on aluminum foil. The prepared electrode was vacuum dried and punched into disks (1.76 cm²) with hard carbon loading of 5-6 mg/disk. The hard carbon working electrode and sodium foil counter/reference electrode were separated by a piece of glass fiber (Whatman® FG/B), wetted with 1 M NaPF₆ in ethylene carbonate (EC) and dimethyl carbonate (DMC) (1:1 in volume). The cell was initially charged at constant current of 0.15 mA until the cell voltage reached 0.0 V then held at 0.0 V until current was less than 0.0015 mA. On discharging, the cell was discharged at 0.15 mA until the cut-off voltage (2.0 V) was reached. A total of 5 cycles was conducted.

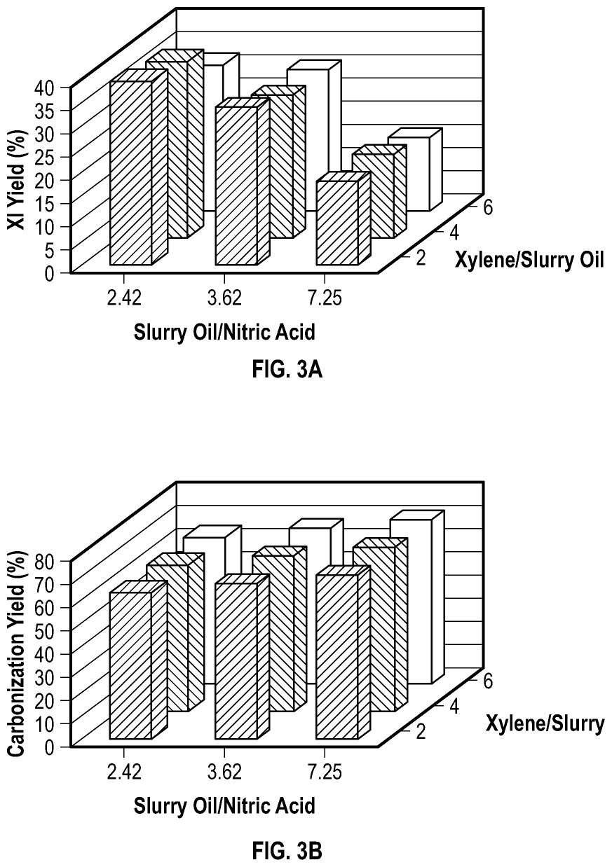

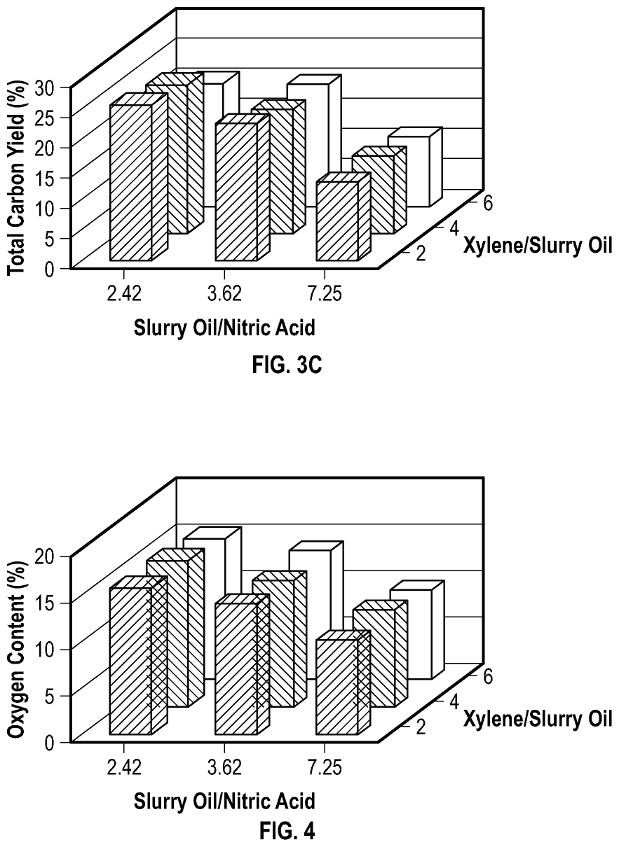

Hard carbon prepared from slurry oil—FIGS. 3A-3C and Table 1 present the yields of xylene insoluble (XI) products (FIG. 3A), carbonization products (FIG. 3B), and total carbon (FIG. 3C). The results showed that those yields were not significantly affected by the xylene/slurry oil ratio, but largely influenced by the nitric acid content. The greater acid content leads to the greater values for the XI yields and the carbon yields. The oxygen contents of products from step (7) were further examined by the CHNS, shown in FIG. 4. Greater acid content results greater oxygen uptake, which exhibits a similar trend of carbon yield. It was assumed that deep acid oxidation would crosslink more small molecules into bigger ones, reducing the volatilization of those species during carbonization. This eventually contributes to the high carbon yield.

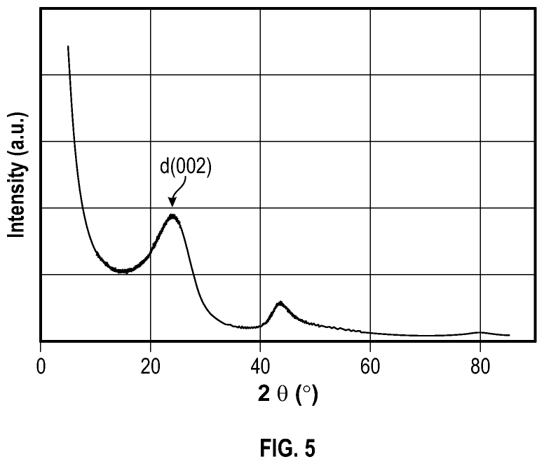

The structure of hard carbon was examined by XRD. As shown in FIG. 5, the diffraction pattern exhibited typical turbostratic structure of hard carbon, featuring broad (002) peak. The lattice information was extracted from (002) peak and the fitting results are listed in Table 1. Although is no appreciable difference in the d-spacings and number of layers between those samples, other properties such as surface defects and morphology would also affect the battery performance. As a result, the reaction condition should be carefully selected. One of the distinguishing features of hard carbon is its internal closed nanopores, which are usually studied by small-angle X-ray scattering. With limited access to this sophisticated characterization tool, correlation of battery performance with crystalline parameters was used to explore the functionality of nanopores.

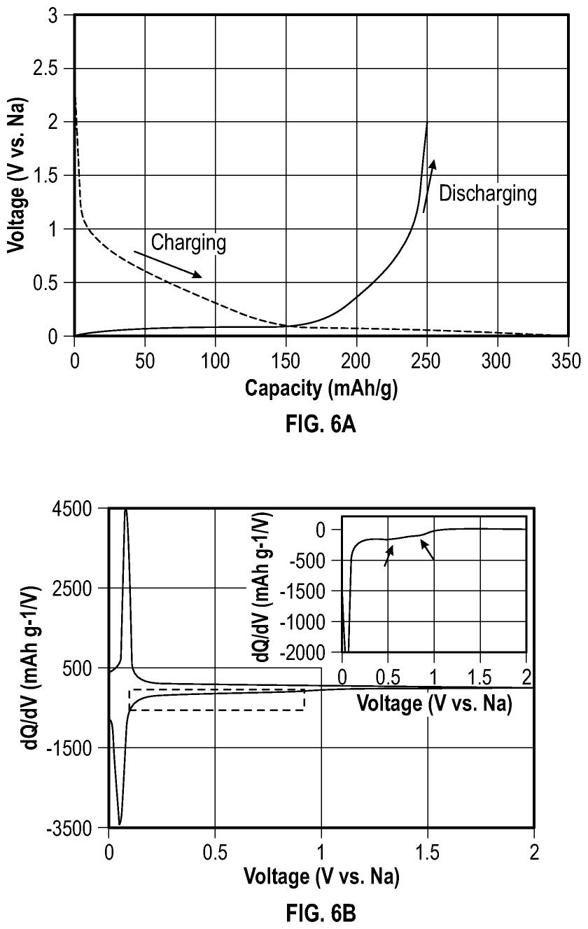

Sodium-ion battery evaluation—FIGS. 6A-6B show graphs which representative first charge/discharge cycle of a hard carbon anode prepared from the slurry oil (FIG. 6A) and differential capacity (FIG. 6B). The graph in FIG. 6A illustrates a slopping region (0.15 V-2.0 V) and a plateau region (0.0 V-0.15 V), which are typically observed for hard carbon. During the initial charge, two peaks at about 0.87 V and about 0.5 V were found in the differential capacity plot. The about 0.5 V peak disappeared in the following cycles, while the about 0.87 V peak remained. It was presumed that electrolyte decomposition occurred at about 0.5 V during the initial charge to form a solid electrolyte interface (SEI), and that the peak at about 0.87 V resulted from sodiation that contributes to the slopping capacity. A pair of strong redox peaks were revealed below 0.1 V, indicating that plateau capacity constituted a large portion of sodiation/de-sodiation taking place at low voltage.

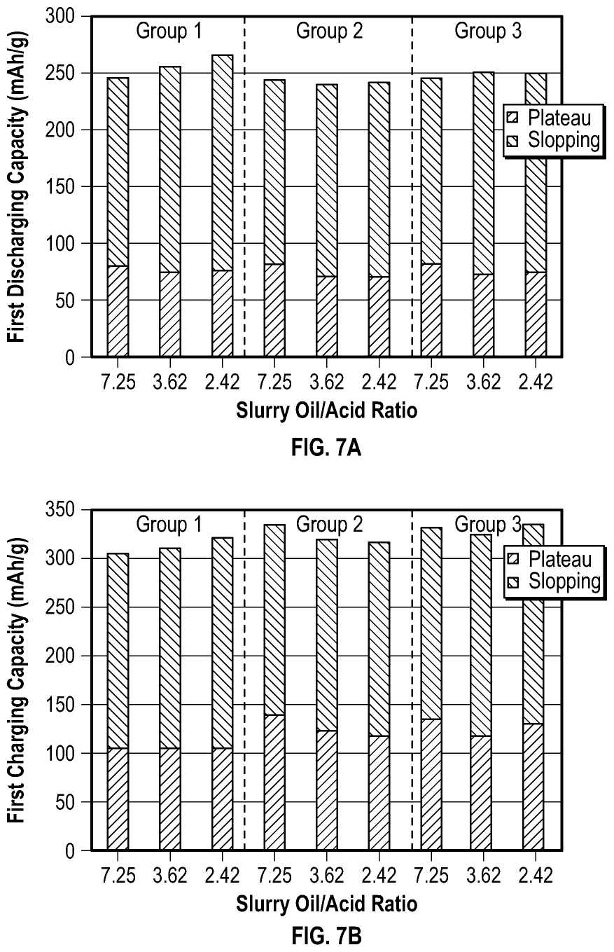

Battery performance for hard carbon materials prepared under different conditions (group preparations, Table 1) was also evaluated and results are presented in FIGS. 6A-6C. The findings are summarized below:
Hard carbons in Group 1 (Examples 1-3) showed greater reversible capacity (FIG. 7(a)) and first cycle efficiency (FIG. 7(c)) than Group 2 (Examples 4-6) and Group 3 (Examples 7-9).
The slopping efficiency (e.g., 60%) is much lower than plateau efficiency (e.g., 80%), presumably owing to sodium consumption during SEI formation and incomplete removal of stored sodium.
It was observed that Groups 2 and 3 reactions were more aggressive than Group 1 reactions, due to greater concentration of reactants. FIG. 7(b) shows that Group 1 had smaller slopping charging capacity than Groups 2 and 3. It suggests that mild oxidation reaction in Group 1 may result in less surface defects and less irreversible capacity.
Within the same Groups, high acid content resulted in larger reversible plateau capacity and smaller slopping capacity.
Taking carbon yield, total reversible capacity and percentage of plateau capacity into consideration, it is concluded that less concentrated slurry oil (high xylene/slurry oil ratio) and high acid content are preferable for the hard carbon preparation.

Examples 10-16: Hard carbon preparation—The heavy fraction from about 500+° C. was used as feedstock for hard carbon preparation and the detailed procedure follows: 1) fully dissolve the slurry oil in xylene (xylene/slurry oil weight ratio 4:1) to form a homogenous mixture; 2) heat the mixture to 65° C. in a silicon oil bath; 3) add concentrated H₂SO₄ (98 wt. %) into the mixture with acid to slurry oil weight ratio of 0.6:1; 4) heat the resulting mixture to the boiling point of xylene (140° C.-150° C.) within 20 min to complete the reaction; 5) additional boiling xylene (xylene/slurry oil weight ratio 2:1) was added to the boiling mixture upon the completion of reaction to fully precipitate the xylene insoluble products; 6) remove the heat and cool the mixture to room temperature (about 23° C.); 7) filter the mixture, wash with xylene, collect and dry the solid product; and 8) for samples prepared below 1500° C., the products from step (7) were heated at a rate of 5° C./min to the desired temperature and held for two hours under a nitrogen atmosphere to complete carbonization. For samples calcinated at temperatures greater than 1,500° C., they were first heated at 900° C. to remove most of volatile species and then calcinated at a graphitization furnace (commercially available from Centorr Vacuum Industries) to the set temperature and held for 15 min. Table 1 provides additional details for Examples 10-16.

TABLE 2

| Examples | 10 | 11 | 12 | 13 | 14 | 15 | 16 |
|---|---|---|---|---|---|---|---|
| Carbonization | 950 | 1,200 | 1,400 | 1,500 | 1,800 | 2,000 | 2,400 |
| temperature (° C.) | | | | | | | |
| Slopping capacity (mAh/g) | 93.08 | 75.03 | 71.69 | 64.85 | 52.48 | 39.13 | 25.78 |
| Plateau capacity (mAh/g) | 51.76 | 154.55 | 220.76 | 215.86 | 253.82 | 254.09 | 239.42 |
| Total capacity (mAh/g) | 144.84 | 229.58 | 292.45 | 280.71 | 306.30 | 293.22 | 265.20 |
| 1st cycle efficiency (%) | 44.48 | 68.10 | 81.44 | 78.50 | 85.38 | 85.08 | 81.09 |

Material Characterization—Samples for XRD analysis were packed loosely onto a silicon wafer low-background sample holder and leveled to achieve flat surface. The data was acquired on a Bruker D8 Advance diffractometer with a cooper X-ray source (Cu Kα λ=1.54059 Å), divergent beam primary beam X-ray optics, and a Vantec1 position sensitive detector. Scans were acquired from 5° to 85° 2θ with a 0.03189° step size. XRD data was analyzed using Materials Data Inc., Jade 2010 software. Peak profiles were fit using a Pseudo-Voigt model for peak shape. All major peak parameters, including position, height, and FWHM, were refined.

Sodium-ion Battery Evaluation—The electrode slurry consists of 90 wt. % hard carbon, 5 wt. % carbon black (Super C65, MTI) and 5 wt % PVDF binder (MW 600,000, MTI). The slurry was fully mixed and coated on aluminum foil. The prepared electrode was vacuum dried and punched into disk (1.76 cm²) with hard carbon loading of 5-6 mg/disk. The hard carbon working electrode and sodium foil counter/reference electrode were separated by a piece of glass fiber (Whatman® FG/B), wetted with 1 M NaPF₆ in ethylene carbonate (EC) and dimethyl carbonate (DMC) (1:1 in volume). The cell was initially charged at constant current of 0.15 mA (about 25 mA/g) until cell voltage reached 0.0 V then held at 0.0 V until current was less than 0.0015 mA. On discharging, the cell was discharged at 0.15 mA until the cut-off voltage (2.0 V) was reached. A total of 5 cycles was conducted.

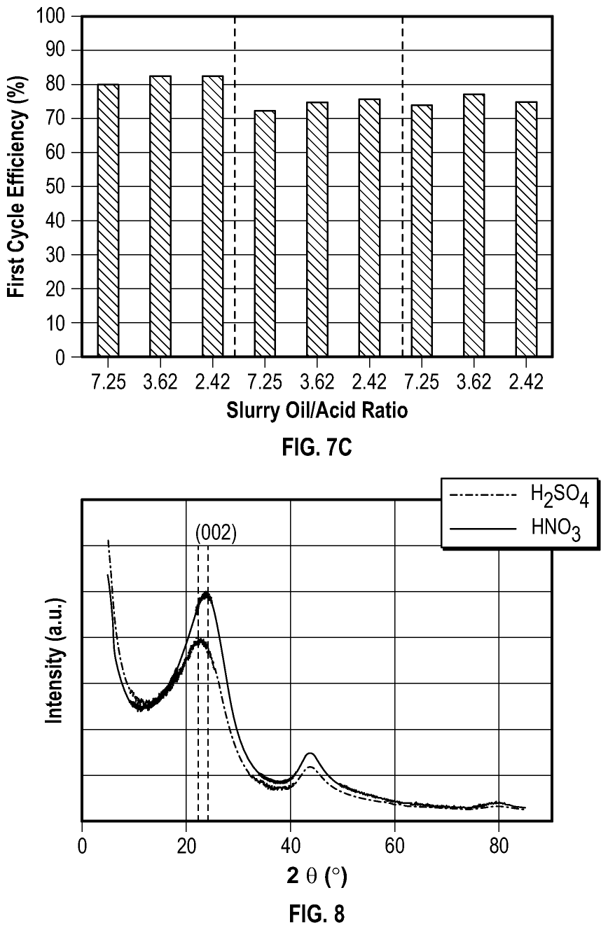

Hard Carbon Prepared by Two Acids—By observation, the reactions using sulfuric acid in Examples 10-16 are different than the reactions using nitric acid in Examples 1-9. The reaction with HNO₃ is more aggressive, evidenced by the large amount of heat and brownish gas released. In contrast, the reaction in H₂SO₄ was mild and did not generate many appreciable heat and gas. The final products after filtration exhibited different physical properties. HNO₃ generated product shows as fine and loosely packed powder, while reacting with H₂SO₄ made product looks like hard rock-like chunks. The carbon yield of H₂SO₄ process (Examples 10-16) is about 40%, greater than about 15% of the HNO₃ process (Examples 1-9). FIG. 8 shows the comparison of XRD pattern of hard carbons after carbonization. Compared to the hard carbon made by H₂SO₄, the (002) peak position of hard carbon prepared HNO₃ shifted towards greater angle, indicating a smaller d (002) spacing (3.83 Å for H₂SO₄ vs. 3.67 Å for HNO₃). The results indicate that the oxidation reaction mechanism of those two acids might be different, resulting in different structures. It is presumed that in the case of H₂SO₄, reactions such as dehydrogenation, polymerization, aromatic sulfonation may also take place before or after crosslink.

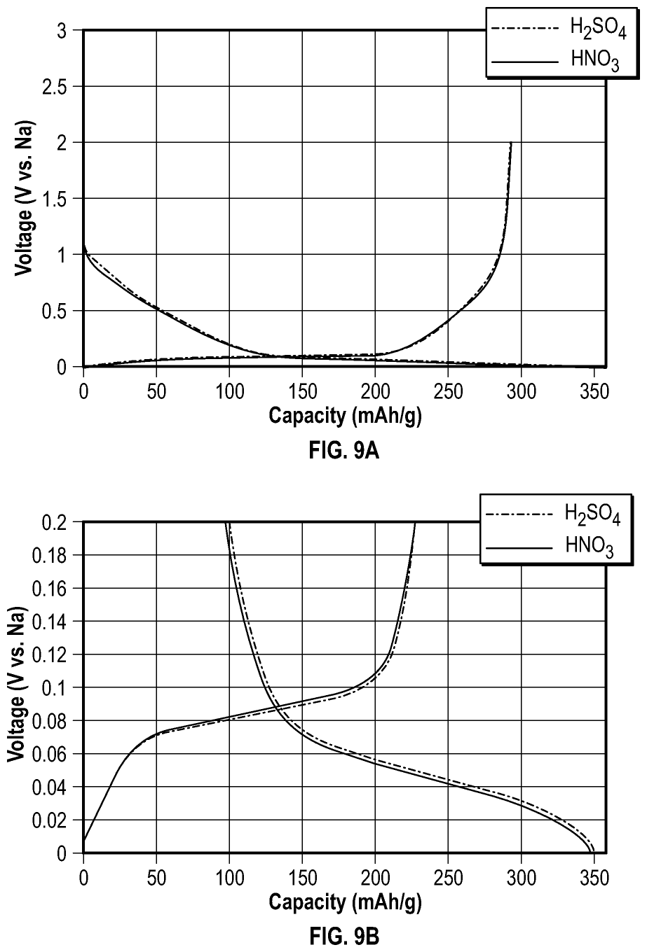

Sodium-ion Battery Evaluation—FIGS. 9A-9B compare the first cycle of two hard carbons (FIG. 9A) and the voltage profile below 0.2 V (FIG. 9B). Overall, there is no appreciable difference between the two samples. Both yield a reversible capacity of 292 mAh/g and first cycle efficiency of 81.4%. One interesting feature is that the sodiation of hard carbon made by H₂SO₄ takes place earlier than that of HNO₃, presumably owing to its larger d (002) spacing that eases the sodiation. Overall, the results showed that H₂SO₄ can serve the similar purpose as HNO₃ to convert slurry oil into hard carbon with similar battery performance. In the following studies, all hard carbons were made by H₂SO₄ unless otherwise specified.

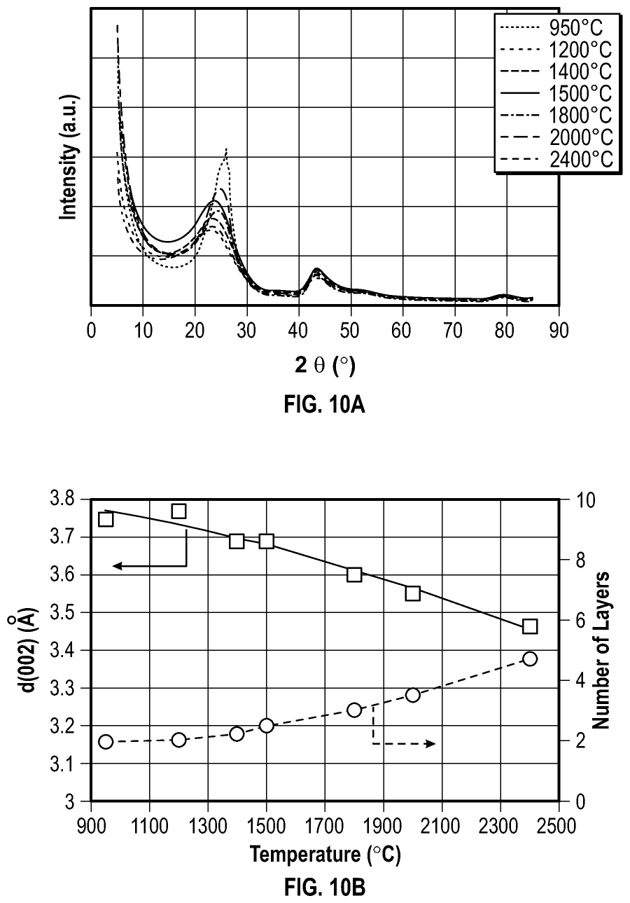

Effect of Temperature—Thermal treatment significantly changes the structures of hard carbon such as interlayer distance and micropore size, which in turn affect the battery performance. As a result, oxidized slurry oils were carbonized in a wide temperature window and XRD was employed to measure their structure. The results for Examples 10-16 are presented in FIGS. 10A-10B. Increasing temperature increased the crystallinity of hard carbons evidenced by the sharper and more symmetric (002) peak. Due to the non-graphitizable nature of hard carbon, they are still in an “amorphous” state even at very high temperature such as 2,400° C., where graphitization should have already taken place. The main (002) peak was used to calculate the interlayer distance (d spacing) and crystallite height (Lc). It was found that d(002) spacing decreased monotonically with increase of temperature while the number of nearly paralleled layers increased. The finding leads to the assumption that increased temperature increases the crystallinity, shrinks the interlayer distance, and regulates the orientation of some randomly oriented graphene layer to increase the total number of paralleled layers.

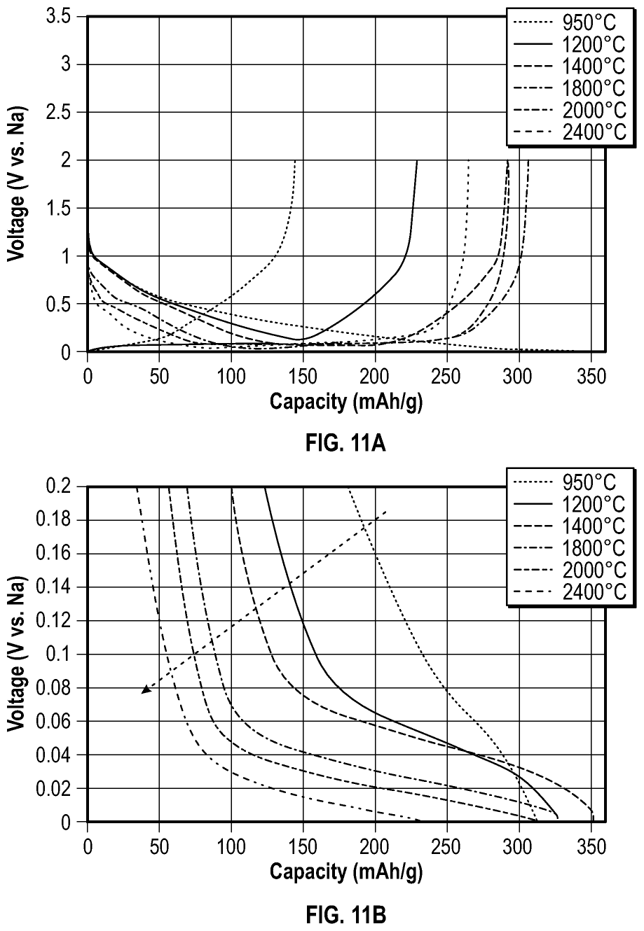

The comparison of SIB performances for Examples 10-16 is displayed in FIGS. 11A-11B and the data is summarized Table 2. The reversible capacity and first cycle efficiency at 950° C. are low and the voltage profile does not show well defined sloping region and plateau region. Increasing temperature to 1,200° C. the total capacity was significantly increased, and the cell developed into a typical charge/discharge profile of hard carbon, showing distinguishing sloping and plateau region. Considering the small difference of crystallite sizes of hard carbons at 950° C. and 1,200° C. (FIG. 10B), it is believed that internal structure other than crystallite size is responsible for the much-increased plateau capacity. Hypothesis will be detailed in the later section. Temperature also affects the potential of sodiation/desodiation (charging/discharging). FIG. 11B illustrates that sodiation potential decreased as temperature increased. In the meantime, d(002) spacing decreased (FIG. 10B). It appears that larger interlayer distance results in earlier sodiation, agreeing with the findings in FIGS. 9A-9B.

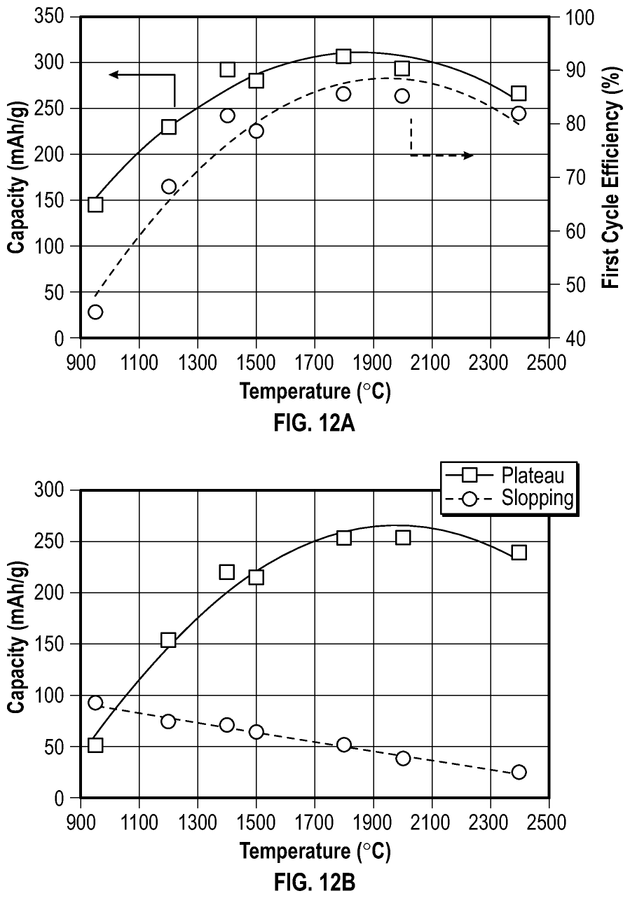

Exploring the Storage Mechanism—FIG. 12A shows the total reversible capacity and first cycle efficiency as a function of temperature. Both exhibit a volcano shape dependence and temperature at approximately 1,800° C. yields the highest performance. The total capacity was further broken down into slopping capacity (0.15 V-2.0 V) and plateau capacity (0.0 V-1.5 V), shown in FIG. 12B. It was found that slopping capacity monotonically decreased with increase of temperature, while plateau capacity shows a volcano shape similar to total capacity. This indicates a different storage mechanism in each region. Lithium exists in two states, an ionic state and a pseudo-metallic state, in lithium storage mechanism for hard carbon. The former was thought to intercalate in the nearly parallel graphene layers and the later was considering as a micropore filling. Although the ionic radius of Li ion and Na and their ionicity bonds with carbon are quite different, the Li storage mechanism in hard carbon may still provide some insights into the Na storage mechanism. The sloping capacity and interlayer distance were plotted in FIG. 12C. Both decreased when temperature was increased, and they followed in a similar decay rate. Given the larger ionic size of Na ion (1.02 Å) than Li ion (0.76 Å), it seems that larger interlayer distance is required to accommodation of Na ion storage. Therefore, it is assumed that Na intercalation between paralleled layer is responsible for the slopping capacity and Na is in an ionic state.

The change plateau capacity did not follow a simple monotonic manner, implying that changes of local or internal structure are more complex than interlayer distance. Based on the results, a possible storage mechanism regarding plateau capacity was proposed here. Two storage sites exist, one is between the interlayer and another is inside the pores. When the calcination temperature is low, the paralleled layer is fewer, the interlayer distance is lager, and internal pores are not completely formed. As a result, sodium is mainly stored between interlayers and SIB mainly exhibits a large slopping capacity, shown in the sample prepared at 950° C. in FIG. 11A. With increase of temperature, disordered graphene layer starts to stack in parallel, interlayer distance shrinks, and pore becomes more defined. Consequently, intercalated Na ion decreased while pore filled Na increased, with total stored Na ion increased. This trend continues until the pore size also starts to shrink and limits further uptake of Na ion, showing a peak plateau capacity and total capacity. Further increasing calcination temperature may result in the collapse of the internal pore, which significantly reduces the pore size. Consequently, very high temperature (e.g., 2,400° C.) reduced both plateau capacity and slopping capacity, leading to the drop of total capacity.

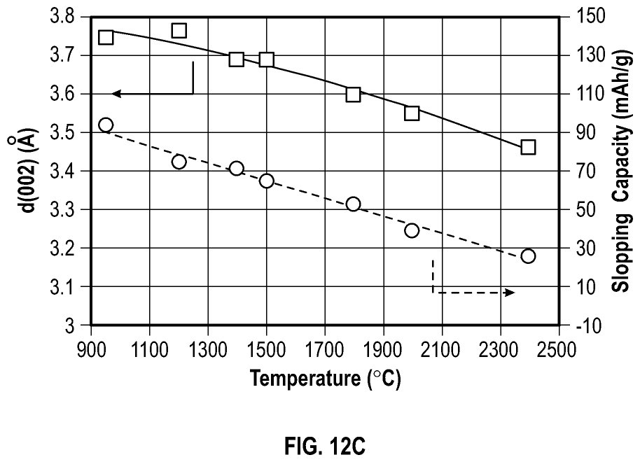

FIGS. 11A-11B show that high calcination temperature reduced the slopping capacity, extended the plateau capacity, and changed the charging voltage, all implying that the onsite potential of sodiation may be different. A comparison of differential capacity is illustrated in FIGS. 13A-13B to investigate this phenomenon. Some findings are summarized below in Items 1-5:

Item 1—All samples prepared at lower or higher temperatures showed a peak at about 0.5 V, which disappeared after 1st cycle, presumably owning to the general solid electrolyte interface (SEI) formation caused by electrolyte decomposition (ethylene carbonate).

Item 2—The potential of second peak at 1st cycle is different for samples at 1,400° C. and 2,000° C., the former is at about 0.9 V and the latter is at about 0.32 V. The intensity was significantly reduced after 1st cycle. It is assumed that sodiation between the interlayer was accompanied by the electrolyte consumption.

Item 3—After 2nd cycle, the curve stabilized. And it clearly showed that sodiation at 1,400° C. occurred much earlier than sample at 2,000° C. It may explain the greater slopping capacity of 1,400° C. than 2,000° C.

Item 4—Large portion of sodiation took place at potentials less than 0.1 V owing to the pore filling.

Item 5—Temperature can be utilized to adjust the charge/discharge potential profile, onsite potential of sodiation, and distribution of slopping and plateau capacity.

Examples 17-21: Hard carbon preparation—The heavy fraction (500+° C.) was used as a feedstock for hard carbon preparation. The detailed procedure for preparing Examples 17-21 includes: 1) fully dissolve the slurry oil in xylene (xylene/slurry oil weight ratio 6:1) to form a homogenous mixture; 2) heat the mixture to 65° C. in a silicon oil bath; 3) add concentrated H₂SO₄ (98 wt %) into the mixture with acid to slurry oil weight ratio of 0.6:1; 4) heat the resulting mixture to the boiling point of xylene (140° C.-150° C.) within 20 min to complete the reaction; 5) remove the heat and cool the mixture to room temperature; 6) filter the mixture, wash with xylene, collect and dry the solid product; 7a) the solid product from step (6) was not further oxidized and used as a Control and labeled as Example 17; 7b) the solid product from step (6) was further oxidized in air in a muffle furnace for 12 hours at the following temperatures for respective samples labeled as: Example 18 at 200° C., Example 19 at 275° C., Example 20 at 300° C., and Example 21 at 325° C.; and 8) The powder obtained from step (7) was heated at a rate of 5° C./min to 1400° C. and held for two hours under a nitrogen atmosphere to complete carbonization for Examples 17-21.

Material Characterization—CHNS analysis was used to measure the elemental composition of solid powder obtained from step (7). Typically, combustion process converts carbon, hydrogen and nitrogen into gas species, which are detected and analyzed by the GC. XRD analysis was employed to study the crystal structure of hard carbon. Samples for packed loosely onto a silicon wafer low-background sample holder and leveled to achieve flat surface. The data was acquired on a Bruker D8 Advance diffractometer with a cooper X-ray source (Cu Kα λ=1.54059 Å), divergent beam primary beam X-ray optics, and a Vantec1 position sensitive detector. Scans were acquired from 5° to 85° 2θ with a 0.03189° step size. XRD data was analyzed using Materials Data Inc. Jade 2010 software. Peak profiles were fit using a Pseudo-Voigt model for peak shape. All major peak parameters, including position, height, and full-width half-maximum, were refined.

Sodium-Ion Battery Evaluation—The electrode slurry consists of 90 wt % hard carbon, 5 wt % carbon black (Super C65, MTI) and 5 wt % PVDF binder (MW 600,000, MTI). The slurry was fully mixed and coated on aluminum foil. The prepared electrode was vacuum dried and punched into disk (1.76 cm²) with hard carbon loading of 5-6 mg/disk. The hard carbon working electrode and sodium foil counter/reference electrode were separated by a piece of glass fiber (Whatman® FG/B), wetted with 1 M NaPF₆ in ethylene carbonate (EC) and dimethyl carbonate (DMC) (1:1 in volume). The cell was initially charged at constant current of 0.15 mA (about 25 mA/g) until cell voltage reached 0.0 V then held at 0.0 V until current was less than 0.0015 mA. On discharging, the cell was discharged at 0.15 mA until the cut-off voltage (2.0 V) was reached. A total of 5 cycles was conducted.

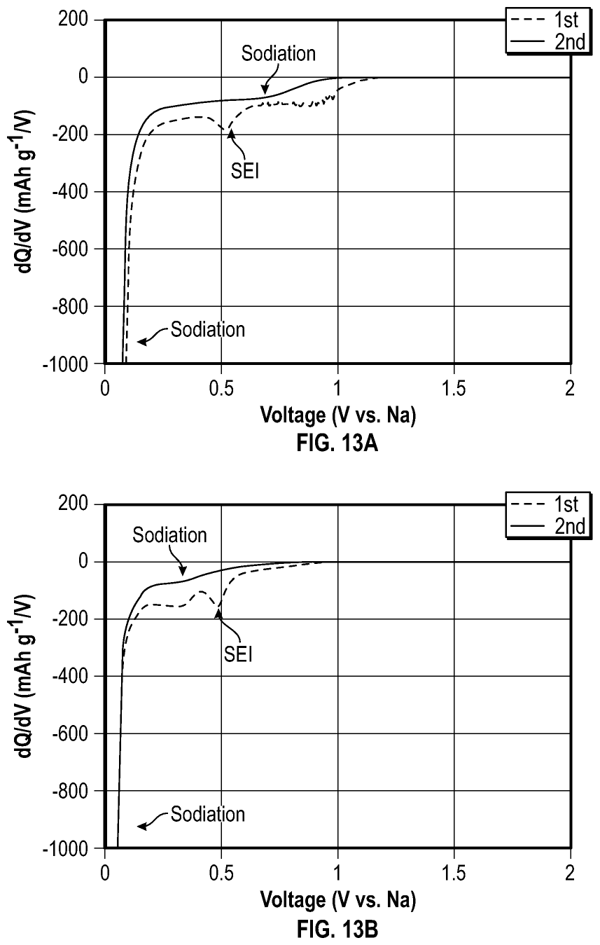

Effect of Second Oxidation on the Hard Carbon Structure—The second oxidation was applied directly after acid oxidation. The effect of the second oxidation on the oxygen content of oxidized slurry oil intermediates was presented in FIG. 14A for Examples 18-21. The oxygen content increased as increase of temperature, indicating that some species (e.g., not fully oxidized species) can be further oxidized and greater temperature promotes the reaction. It is worth noting that mass loss was found during the second oxidation, for example about 20 wt % at 200° C. (Ex. 18) and about 45% at 325° C. (Ex. 21). There are several possible causes, such as: 1) The filtering step cannot fully wash off H₂SO₄ and because of its high boiling point (greater than 300° C.) conventional drying step cannot evaporate H₂SO₄. The H₂SO₄ residual may catalyze the intermediates during the second oxidation. 2) Species that were not cross-linked may be burned off at greater temperature. 3) Unreacted hydrocarbons that were extracted by xylene may also be burned off.

The additional oxygen uptake during the second oxidation is expected to form additional crosslinking and prevent parallel stacking during carbonization. The structure of hard carbon for Examples 17-21 was further examined by XRD and the result is shown in FIG. 14C. Compared to the pristine hard carbon, the interlayer distance d (002) of hard carbon subjected to second oxidation slightly increased by 0.7% at 325° C., possible due to crosslinking which disrupted graphene layers from neatly stacking. The decrease of the crystal domain thickness (Lc (002)) was pronounced (e.g., reduced by 15% at 325° C.), implying that a smaller crystal size and more disordered structure were produced.

In some examples, since H₂SO₄ is a weak oxidizer, the oxidation is insufficient and the degree of crosslinking is limited. As a result, graphene (e.g., aromatic species) tends to stack in parallel and form larger crystal size. In contrast, the second oxidation introduces additional crosslinking groups that prevent them from stacking and ordering, resulting in a smaller crystal size. More importantly, it's likely that some of unstacked and disordered graphene layers might form nanopores inside the hard carbon, and second oxidation may favor the formation of such porous structure due to its higher availability of irregular graphene layers.

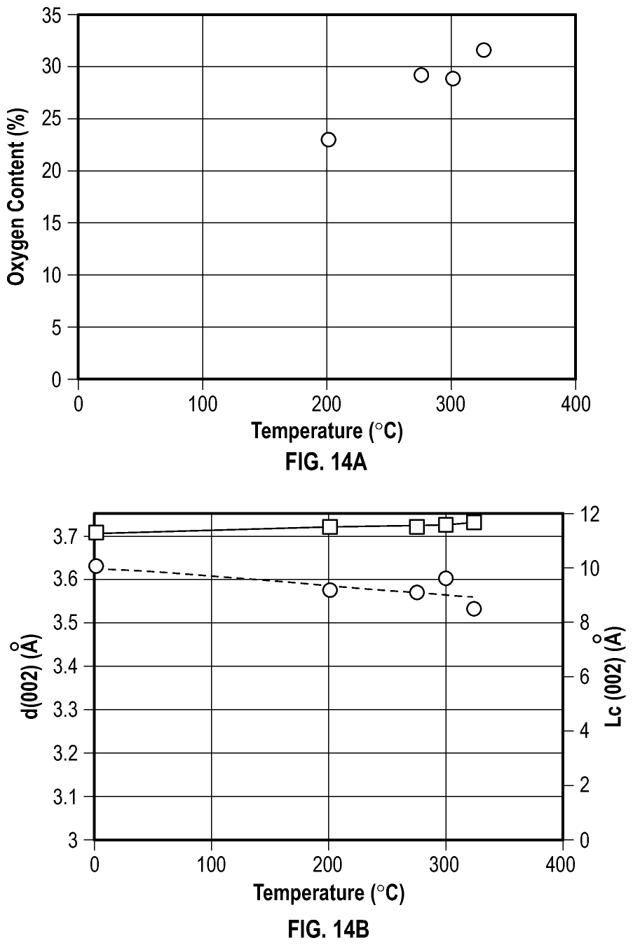

Battery Evaluation—FIGS. 15A-15C are graphs which display the results of battery evaluation in half coin cells. Compared to the pristine hard carbon, one subjected to the second oxidation showed increased reversible capacity and greater oxidation temperature results in greater capacity. The total capacity was further broken down into plateau capacity and sloping capacity, shown in FIG. 15B. It was found that the plateau capacity increased with greater temperatures, while sloping capacity remained almost the same. The results provide that the intercalation between interlayer and pore filling mechanism are responsible for the sloping capacity and plateau capacity, respectively. As a result, it's believed that second oxidation produces more nanopores that increase the plateau capacity in some examples. This supports the hypothesis that second oxidation promotes the nanopore formation in these examples. FIG. 15B shows the first cycle efficiency (FCE), which slightly increased and stabilized at about 80%. Further examination of the irreversible capacity revealed that it almost did not change and stabilized at about 74 mAh/g, indicating that second oxidation did not produce additional surface defects that may cause electrolyte consumption. Therefore, the increase of FCE is presumed owing to the increase of plateau capacity, which has greater FCE than sloping capacity.

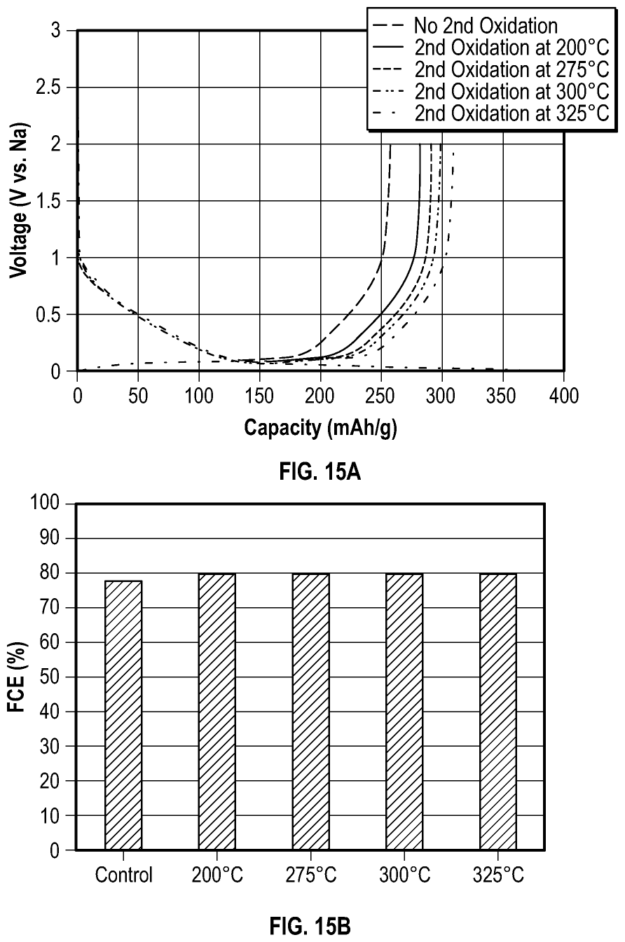

Arrhenius equation describes the relationship between reaction rate (k) and temperature (1/T). By plotting 1st cycle charge/discharge capacity (ln(capacity) as a function of second oxidation temperature (1/T), a linear relationship was observed, shown in FIG. 16. It's speculated that second oxidation can help to achieve a fully oxidized state that has not been completed during acid oxidation and second oxidation may reveal the intrinsic performance of the materials.

As described above, second oxidation temperature results in additional weight loss. FIG. 15 plots the carbon yield and reversible capacity as a function of oxidation temperature for Examples 17-21. The capacity slowly increases at a rate less than 1 mAh/° C., in contrast to the drastic drop of the carbon yield. It is likely that second oxidation breaks the originally aggregated species into smaller ones, which are more prone to be thermally decomposed into gases (e.g., CO₂ or H₂O). As a result, smaller crystal size and void pores were produced at the expense of lower carbon yield. To achieve reversible capacity greater than 300 mAh/g and decent carbon yield, oxidation at about 300° C. is reasonable.

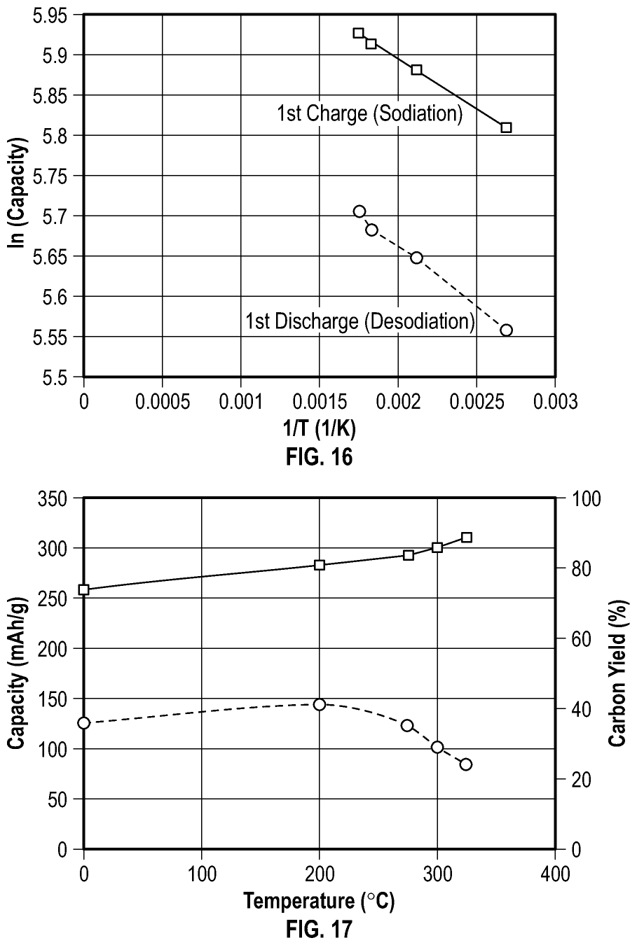

The second oxidation process is a gas/solid reaction, because the acid oxidized intermediate is solid. Due to the slow diffusion of air in the solid phase, the oxidation time may affect the hard carbon structure. Oxidation time of 3 h was compared with 12 h, and the result is shown in FIG. 18. The 12 h sample outperformed the 3 h sample, mainly owing to the difference of plateau capacity (inset figure). Measurements of oxygen content of slurry oil intermediates, d(002) and Lc(002) were further conducted for study the effect of duration time. For the 3 h sample, those values are 25.36% (0%), 3.71 Å (d(002)), and 9.56 Å (Lc(002)). While for the 12 h sample, they are 28.73% (0%), 3.71 Å (d(002)), and 9.48 Å (Lc(002)). Therefore, the greater oxygen content of intermediates and smaller crystallite size of the 12 h sample is believed to be the main cause of greater capacity than the 3 h sample. In summary, the findings suggest that greater oxidation temperature and longer duration may favor the hard carbon performance.

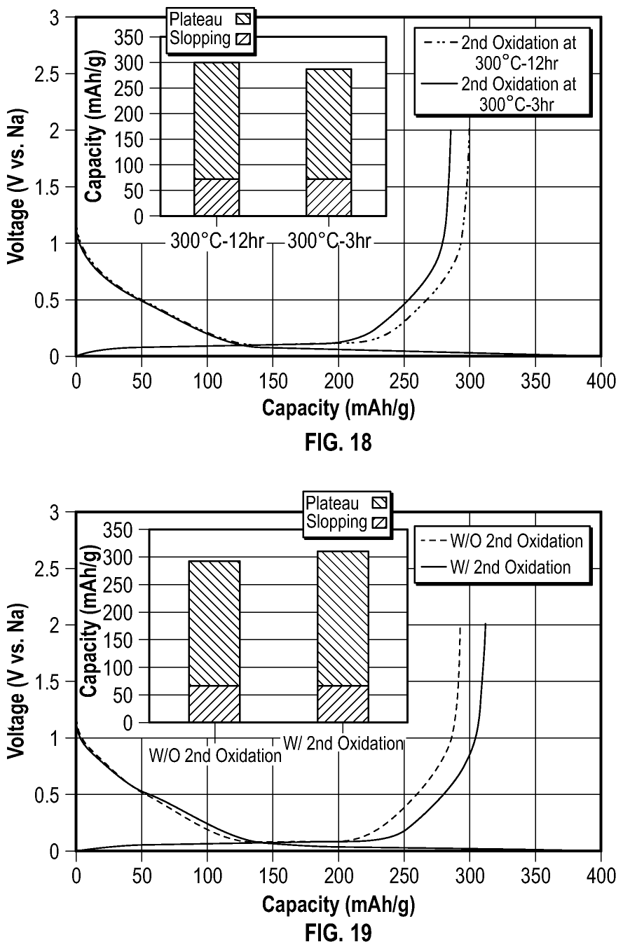

FIG. 19 is a graph illustrating that a sample that was deficient in oxygen concentration and exposed to the second oxidation has improved performance over a sample of the same material not exposed to a second oxidation. The further oxidized sample has increase in capacity to greater than 310 mAh/g. It appears that this approach can be applied to the oxidized slurry oil intermediates (e.g., partially oxidized solid product) that have not reached high oxygen content.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated. As used herein, the term “about” refers to a +/−10% variation from the nominal value. It is to be understood that such a variation can be included in any value provided herein.

Certain embodiments and features have been described using a set of numerical minimum values and a set of numerical maximum values. It should be appreciated that ranges including the combination of any two values, e.g., the combination of any minimum value with any maximum value, the combination of any two minimum values, and/or the combination of any two maximum values are contemplated unless otherwise indicated. Certain minimum values, maximum values, and ranges appear in one or more claims below.

What is claimed is:

1. A method for preparing an anode carbon material, comprising:
combining a liquid refinery hydrocarbon product and a solvent to produce a first mixture;
combining the first mixture and a first oxidizing agent comprising an acid to produce a second mixture comprising the liquid refinery hydrocarbon product, the solvent, and the first oxidizing agent;
heating the second mixture to produce a reaction mixture comprising an oxidized solid product during an oxidation process;
separating the oxidized solid product from the reaction mixture during a separation process; and
carbonizing the oxidized solid product to produce a hard carbon product during a carbonization process.

2. The method of claim 1, wherein the second mixture is heated to a process temperature of about 100° C. to about 200° C. during the oxidation process.

3. The method of claim 1, wherein the separation process further comprises:
adding an additional amount of the solvent to the reaction mixture; and
filtering the oxidized solid product from the solvent.

4. The method of claim 1, wherein the oxidized solid product comprises at least 15 wt % of oxygen.

5. The method of claim 1, wherein the liquid refinery hydrocarbon product comprises a fluid catalytic cracking (FCC) slurry oil, a heavy hydrocarbon stream comprising polyaromatic hydrocarbons, a coker gas oil, a vacuum gas oil, or any combination thereof.

6. The method of claim 1, wherein the solvent comprises xylene, toluene, benzene, pyridine, mesitylene, benzyl alcohol, benzonitrile, nitrobenzene, one or more halo-aromatic compounds, or any combination thereof.

7. The method of claim 1, wherein the first mixture has a weight ratio of the solvent to the liquid refinery hydrocarbon product of about 2 to about 10.

8. The method of claim 1, wherein separating the oxidized solid product from the reaction mixture comprises skimming or filtering the oxidized solid product from the reaction mixture.

9. The method of claim 1, wherein the first oxidizing agent comprises nitric acid, sulfuric acid, chlorous acid, chloric acid, perchloric acid, chromic acid, derivatives thereof, salts thereof, or any combination thereof.

10. The method of claim 1, wherein the first oxidizing agent comprises sulfuric acid or nitric acid at a concentration of about 50 weight percent (wt %) or greater.

11. The method of claim 1, wherein the carbonization process comprises heating the oxidized solid product at a temperature of about 1,000° C. to about 3,000° C. for about 1 minute to about 10 hours.

12. The method of claim 1, wherein after the separation process and before the carbonization process, further comprising exposing the oxidized solid product to a second oxidizing agent during a second oxidizing process.

13. The method of claim 1, wherein the second oxidizing agent comprises air, oxygen (O₂), or a combination thereof.

14. A method for preparing an anode carbon material, comprising:
combining a first mixture and a first oxidizing agent comprising an acid to produce a second mixture comprising a liquid refinery hydrocarbon product, a solvent, and the first oxidizing agent, wherein the first mixture has a weight ratio of the solvent to the liquid refinery hydrocarbon product of about 2 to about 10;
heating the second mixture to produce a reaction mixture comprising an oxidized solid product during an oxidation process;
combining an additional amount of the solvent to the reaction mixture;
separating the oxidized solid product from the reaction mixture during a separation process; and
carbonizing the oxidized solid product to produce a hard carbon product during a carbonization process.

15. The method of claim 14, wherein the second mixture is heated to a process temperature of about 100° C. to about 200° C. during the oxidation process.

16. The method of claim 14, wherein the oxidized solid product comprises at least 15 wt % of oxygen.

17. The method of claim 14, wherein the liquid refinery hydrocarbon product comprises a fluid catalytic cracking (FCC) slurry oil, a heavy hydrocarbon stream comprising polyaromatic hydrocarbons, a coker gas oil, a vacuum gas oil, or any combination thereof, and wherein the solvent comprises xylene, toluene, benzene, pyridine, mesitylene, benzyl alcohol, benzonitrile, nitrobenzene, one or more halo-aromatic compounds, or any combination thereof.

18. The method of claim 14, wherein the first oxidizing agent comprises nitric acid, sulfuric acid, chlorous acid, chloric acid, perchloric acid, chromic acid, derivatives thereof, salts thereof, or any combination thereof, and wherein the first oxidizing agent comprises sulfuric acid or nitric acid at a concentration of about 50 weight percent (wt %) or greater.

19. A method for preparing an anode carbon material, comprising:
combining a first mixture and a first oxidizing agent comprising an acid to produce a second mixture comprising a liquid refinery hydrocarbon product, a solvent, and the first oxidizing agent, wherein the first mixture comprises the solvent and the liquid refinery hydrocarbon product, and the acid comprises nitric acid or sulfuric acid;
heating the second mixture to produce a reaction mixture comprising an oxidized solid product during an oxidation process, wherein the oxidized solid product comprises at least 15 wt % of oxygen;
separating the oxidized solid product from the reaction mixture during a separation process; and
carbonizing the oxidized solid product to produce a hard carbon product during a carbonization process.

20. The method of claim 19, wherein the second mixture is heated to a process temperature of about 100° C. to about 200° C. during the oxidation process.

21. The method of claim 19, wherein the liquid refinery hydrocarbon product comprises a fluid catalytic cracking (FCC) slurry oil, a heavy hydrocarbon stream comprising polyaromatic hydrocarbons, a coker gas oil, a vacuum gas oil, or any combination thereof, and wherein the solvent comprises xylene, toluene, benzene, pyridine, mesitylene, benzyl alcohol, benzonitrile, nitrobenzene, one or more halo-aromatic compounds, or any combination thereof.

22. The method of claim 19, wherein the first oxidizing agent comprises sulfuric acid or nitric acid at a concentration of about 50 weight percent (wt %) or greater.
